(19) United States
(12) Patent Application Publication
(10) Pub. No.: US 2009/0313133 A1
(43) Pub. Date: Dec. 17, 2009

(54) AUCTION SYSTEM, INFORMATION PROCESSING DEVICE, INFORMATION PROCESSING METHOD, RECORDING MEDIUM, AND PROGRAM

(76) Inventor: Kouichi Shimizuta, Tokyo (JP)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 11/912,418

(22) PCT Filed: May 9, 2006
(86) PCT No.: PCT/JP2006/309299

§ 371 Date: Aug. 3, 2009

(30) Foreign Application Priority Data
May 23, 2005 (JP) JP2005-149072

(51) Int. Cl. G06Q 30/00; G06Q 50/00; G06F 17/30; G06F 17/40; G06Q 10/00

(52) U.S. Cl. 705/26; 707/100; 707/5; 707/E17.017; 707/E17.044

(57) ABSTRACT

The present invention has an object to offer an auction system or the like which also plays the role of a supplementary function for the realization of commodity idea.

There is disclosed an auction system provided with idea information storing means, estimate information storing means, auction information storing means, a process of creating data of cumulative total classified by bid price versus sales by processing product calculation of cumulative total for every bid price, which is obtained by a process of adding bid intention quantity sequentially from high-price bid price to low-price bid price and the corresponding bid price, a process of creating data of cumulative total classified by bid price versus embodiment cost by processing product calculation of cumulative total and embodiment amount of money per embodiment unit quantity which corresponds to the cumulative total, and extracting means for performing a process of comparing the data of cumulative total classified by bid price versus sales and the data of cumulative total classified by bid price versus embodiment cost and for extracting a bid price which satisfies a predetermined condition.

### TECHNICAL FIELD

The present invention relates to an information processing apparatus, an information processing method, a recording medium and a program, and particularly to an auction system.

### BACKGROUND ART

On the internet, there exists a web site (auction site) holding a service referred to as an internet auction in which exhibit or bid procedure relating to the auction can be carried out by making the web page to be the medium thereof. The auction site is held based on the www server as a main constituent by means of a computer-system including a computer and database working together therewith. This system offers user interface by a web page to a computer of an auction participant (user computer) and accepts exhibits and bids in the auction through this web page. Also, management of private information relating to the auction participants is carried out and if an auction matter made by a successful bid occurs, the fact thereof is notified to the exhibitor and the successful bidder who become the transaction parties and intermediate service is done such that the transfer of the successful bid price thereafter can be carried out smoothly between the parties involved (for example, see Patent Document 1).

[Patent Document 1]

Japanese unexamined patent publication No. 2004-192438

The auction carried out on a communication service such as internet and the like is also referred to as an online auction and is a kind of electronic commerce (EC).

A business which offers a system and a “place” for carrying out these series of processes has been expanded rapidly.

In recent years, there has been also proposed a system in which collection and publication of commodity ideas and business talk with the production applicants for the commodities relating to the published commodity ideas are carried out through the internet (for example, see Patent Document 2).

[Patent Document 2]

Japanese unexamined patent publication No. 2004-133825

However, only by offering a chance for carrying out merely a business talk or the like on the internet, possibility of realizing the commodity idea cannot be large and also other factors are necessary for the realization of the commodity idea.

### DISCLOSURE OF THE INVENTION

### Problem to be Solved by the Invention

The present invention was invented in view of the background art described above and has an object to offer an auction system, an information processing apparatus, an information processing method, a recording medium, and a program in which the commodity idea also becomes a supplementary function for the realization thereof.

### Means for Solving the Problem

According to the present invention, there are employed, in order to achieve the object described above, with configurations just as described in the patent claims. Hereinafter, the present invention will be explained in detail.

A first aspect of the present invention lies, in an auction system in which a first computer and a second computer are connected to an auction unit computer through a communication network, in an auction system characterized in that aforesaid auction unit computer comprises:
idea information storing means in which idea information is stored;
estimate information storing means in which an embodiment amount of money per embodiment unit quantity which is transmitted from aforesaid first computer and responds to idea embodiment quantity is stored by being correlated with aforesaid idea information;
auction information storing means in which bid price and bid quantity which are transmitted from aforesaid second computer are stored by being correlated with aforesaid idea information;
a process of creating data of cumulative total classified by bid price versus sales by processing product calculation of cumulative total for every bid price which is obtained by additively processing bid intention quantity sequentially from high-price bid price to low-price bid price and the corresponding bid price;
a process of creating data of cumulative total classified by bid price versus embodiment cost by processing product calculation of aforesaid cumulative total and an embodiment amount of money per embodiment unit quantity which corresponds to aforesaid cumulative total; and
extracting means carrying out a process of extracting bid price which satisfies a predetermined condition by comparing aforesaid data of cumulative total classified by bid price versus sales and aforesaid data of cumulative total classified by bid price versus embodiment cost.

According to this configuration, actual selling price or the like can be judged accurately, so that marketing function can be expected.

A second aspect of the present invention lies in an auction system, characterized in that aforesaid auction unit computer is further connected with a third computer through a communication network, and aforesaid idea information storing means is stored with idea information transmitted from aforesaid third computer.

According to this configuration, it is possible to attempt realization of ideas broadly based on the marketing function.

A third aspect of the present invention lies in an auction system, characterized in that aforesaid auction unit computer further comprises means for transmitting aforesaid idea information with respect to aforesaid first computer or aforesaid second computer.

According to this configuration, it is possible to get ideas known broadly and to induce various kinds of views.

A fourth aspect of the present invention lies in an auction system, characterized in that aforesaid auction unit computer is further connected with a fourth computer through a communication network, and aforesaid auction unit computer further comprises means for receiving payment information corresponding to bidding from aforesaid fourth computer.

According to this configuration, it is possible to decrease financial risk by dealing with also payment information after the bid.

A fifth aspect of the present invention lies in an information processing apparatus, characterized by comprising:
idea information storing means in which idea information is stored;
estimate information storing means in which an embodiment amount of money per embodiment unit quantity responding to idea embodiment quantity is stored by being correlated with aforesaid idea information;
auction information storing means in which bid price and bid quantity are stored by being correlated with aforesaid idea information;
a process of creating data of cumulative total classified by bid price versus sales by processing product calculation of cumulative total for every bid price which is obtained by additively processing bid intention quantity sequentially from high-price bid price to low-price bid price and the corresponding bid price;
a process of creating data of cumulative total classified by bid price versus embodiment cost by processing product calculation of aforesaid cumulative total and an embodiment amount of money per embodiment unit quantity which corresponds to aforesaid cumulative total; and
extracting means carrying out a process of extracting bid price which satisfies a predetermined condition by comparing aforesaid data of cumulative total classified by bid price versus sales and aforesaid data of cumulative total classified by bid price versus embodiment cost.

According to this configuration, actual selling price or the like can be judged accurately, so that marketing function can be expected.

A sixth aspect of the present invention lies in an information processing apparatus, characterized in that aforesaid estimate information storing means is stored with an embodiment amount of money per embodiment unit quantity responding to idea embodiment quantity together with ID information of an embodiment person by being correlated with aforesaid idea information, and aforesaid extracting means further extracts ID information of an embodiment person, which satisfies a predetermined condition.

According to this configuration, it is possible to carry out also the determination of the embodiment person.

A seventh aspect of the present invention lies in an information processing method, characterized by comprising: an idea information storing step in which idea information is stored;
an estimate information storing step in which an embodiment amount of money per embodiment unit quantity responding to idea embodiment quantity is stored by being correlated with aforesaid idea information;
an auction information storing step in which bid price and bid quantity are stored by being correlated with aforesaid idea information;
a process of creating data of cumulative total classified by bid price versus sales by processing product calculation of cumulative total for every bid price which is obtained by additively processing bid intention quantity sequentially from high-price bid price to low-price bid price and the corresponding bid price;
a process of creating data of cumulative total classified by bid price versus embodiment cost by processing product calculation of aforesaid cumulative total and an embodiment amount of money per embodiment unit quantity which corresponds to aforesaid cumulative total; and
an extracting step carrying out a process of extracting bid price which satisfies a predetermined condition by comparing aforesaid data of cumulative total classified by bid price versus sales and aforesaid data of cumulative total classified by bid price versus embodiment cost.

According to this configuration, actual selling price or the like can be judged accurately, so that marketing function can be expected.

An eighth aspect of the present invention lies, in a program for an information process of an information processing apparatus, in a recording medium recorded with a program readable by a computer, characterized by comprising:
an idea information storing step in which idea information is stored;
an estimate information storing step in which an embodiment amount of money per embodiment unit quantity responding to idea embodiment quantity is stored by being correlated with aforesaid idea information;
an auction information storing step in which bid price and bid quantity are stored by being correlated with aforesaid idea information;
a process of creating data of cumulative total classified by bid price versus sales by processing product calculation of cumulative total for every bid price which is obtained by additively processing bid intention quantity sequentially from high-price bid price to low-price bid price and the corresponding bid price;
a process of creating data of cumulative total classified by bid price versus embodiment cost by processing product calculation of aforesaid cumulative total and an embodiment amount of money per embodiment unit quantity which corresponds to aforesaid cumulative total; and
an extracting step carrying out a process of extracting bid price which satisfies a predetermined condition by comparing aforesaid data of cumulative total classified by bid price versus sales and aforesaid data of cumulative total classified by bid price versus embodiment cost.

According to this configuration, actual selling price or the like can be judged accurately, so that marketing function can be expected.

An ninth aspect of the present invention lies, in a program making a computer which controls an information processing apparatus to carry out an information process, in a program characterized by comprising:
an idea information storing step in which idea information is stored;
an estimate information storing step in which an embodiment amount of money per embodiment unit quantity responding to idea embodiment quantity is stored by being correlated with aforesaid idea information;
an auction information storing step in which bid price and bid quantity are stored by being correlated with aforesaid idea information;
a process of creating data of cumulative total classified by bid price versus sales by processing product calculation of cumulative total for every bid price which is obtained by additively processing bid intention quantity sequentially from high-price bid price to low-price bid price and the corresponding bid price;
a process of creating data of cumulative total classified by bid price versus embodiment cost by processing product calculation of aforesaid cumulative total and an embodiment amount of money per embodiment unit quantity which corresponds to aforesaid cumulative total; and
an extracting step carrying out a process of extracting bid price which satisfies a predetermined condition by comparing aforesaid data of cumulative total classified by bid price versus sales and aforesaid data of cumulative total classified by bid price versus embodiment cost.

According to this configuration, actual selling price or the like can be judged accurately, so that marketing function can be expected.

It should be noted that the computer-program is a computer-program which can offer a program with respect, for example, to a general-purpose computer-system in which various kinds of program-codes are practicable by using a storage medium or a communication medium, for example, a storage medium of CD, FD, MO or the like, or a communication medium of network or the like which offers a program in a form readable by a computer. By offering such a program in a form readable by a computer, processes responding to the program can be realized on the computer-system.

### Effect of the Invention

According to the present invention, marketing function can be expected.

Still other objects, features or advantages of the present invention will become clear according to the detailed explanation based on exemplified embodiments of the present invention or attached drawings which will be described later.

### BRIEF DESCRIPTION OF DRAWINGS

FIG. 1 is a diagram showing correlation of hardware.

FIG. 2 is a configuration diagram of software in a server 110.

FIG. 3 is a flowchart relating to initial display.

FIG. 4 is a flowchart relating to registration login for an exhibitor.

FIG. 5 is a flowchart relating to utilization page for an exhibitor.

FIG. 6 is a flowchart relating to analysis of exhibitor selection items.

FIG. 7 is a flowchart relating to selling price determination of an exhibitor.

FIG. 8 is a flowchart relating to recounting and reexamination with respect to commodity of an exhibitor.

FIG. 9 is a flowchart relating to final procedure of an exhibitor.

FIG. 10 is a flowchart relating to registration login for a producer.

FIG. 11 is a flowchart relating to a utilization page for production.

FIG. 12 is a flowchart relating to an estimate bid list and a final process of a producer.

FIG. 13 is a flowchart relating to registration login for a buyer.

FIG. 14 is a flowchart relating to an auction page for a buyer.

FIG. 15 is a flowchart relating to auction participation of a buyer.

FIG. 16 is a flowchart relating to successful bid charge transferring process of a buyer.

FIG. 17 is a diagram showing one example of an operation procedure of the WEB site page.

FIG. 18 is a graph of cumulative number versus sales profit and loss in which a table of cumulative number versus sales profit and loss calculated provisionally as tertiary data was graphed.

FIG. 19 is a configuration example of a computer installed with a program which executes a series of processes.

### DESCRIPTION OF REFERENCE NUMERALS

110: server which is a ┌computer provided with auction function and calculating function of cumulative profit maximum price┘

120: computer possessed by a producer who is a ┌person who wants to receive business for commodification with respect to original idea of commodity┘

130: computer possessed by an exhibitor who is a ┌person who conceives commodity┘

140: computer possessed by a buyer who is a ┌person who has purchase desire or stock sales desire with respect to original idea of commodity┘

150: computer possessed by cooperated financial institution

P1: input/output control unit

P2: utilization control unit

D1: member data

D2: commodity data

D3: estimate data

D4: auction data

MP1: main program

### BEST MODE FOR CARRYING OUT THE INVENTION

Hereinafter, it will be explained with respect to exemplified embodiments of the present invention in detail with reference to drawings.

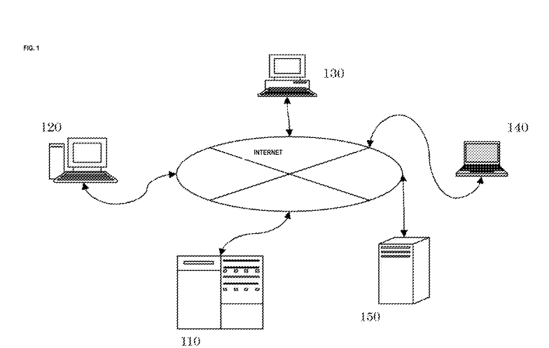

FIG. 1 is a diagram showing hardware correlation of these exemplified embodiments. A computer 130 possessed by an exhibitor who is a ┌person who conceives a commodity┘, a computer 120 possessed by a producer who is a ┌person who wants to receive business for commodification with respect to an original idea of the commodity┘, a computer 140 possessed by a buyer who is a ┌person who has purchase desire or stock sales desire with respect to the original idea of the commodity┘, and a computer 150 possessed by a cooperated financial institution are connected through a communication network to a server 110 which is a ┌computer provided with auction function and cumulative profit maximum price calculating function┘, respectively.

The server 110 is provided with an auction function of executing estimate bid of production cost of the producer and executing purchase desired bid of the buyer within a determined period or simultaneously with respect to the exhibitor matter and is provided with a function of executing calculation of cumulative profit maximum price from each of the obtained bid information and executing agency of collection of the bill depending on the cooperated financial institution when carrying out the production and the sales. If acquisition of data is executed through the internet environment, the release of the commodity by which profit securing is reliable and the service thereof become possible and further, it is possible to carry out creation of a proper market.

It should be noted that the communication system between the connected computers or servers is not to be limited by a specific system and it is allowed to utilize, for example, a CDMA (Code Division Multiple Access) communication system, a UWB (Ultra Wide Band) communication system or the like for the communication system.

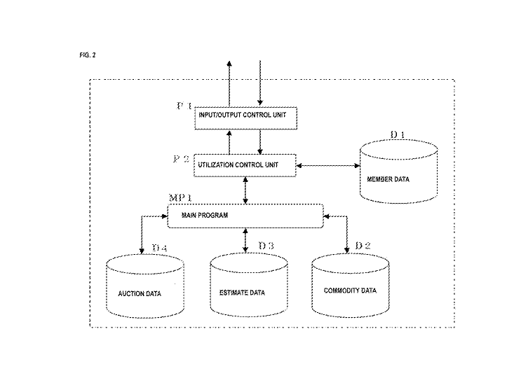

FIG. 2 is a configuration diagram of software in the server 110. The server 110 is constituted by an input/output control unit P1, a utilization control unit P2, member data D1, a main program MP1, auction data D4, estimate data D3 and commodity data D2.

With respect to the computer which accessed the server A through the internet, the input/output control unit P1 executes display of the top page, access processing and display of the explanation page of site usage and judgment of the situation in which login is executed as an exhibitor, login is executed as a producer or login is executed as a buyer.

The utilization control unit P2 processes verification of the login input information in the input/output control unit P1 with the member data D1 and carries out setting of utilization yes or no and utilization function of the main program MP1.

The main program MP1 can execute registration or update of the utilization page or the like with respect to the auction data D4, the estimate data D3 and the commodity data D2 for the information transmitted from the login computer in which the utilization function setting of the main program MP1 was executed by the process of the utilization control unit P2. Also, the main program MP1 normalizes respective data of the member data D1, the auction data D4, the estimate data D3 and the commodity data D2 which were accumulated and performs mutual association process thereamong. Further, the main program MP1 carries out analysis of the exhibitor selection item with respect to the numerical information portion of the information processed for the association, selling price determination of the exhibitor, recounting and reexamination with respect to the commodity of the exhibitor, a theoretical calculation process of the exhibitor final procedure, and the like. Also, the main program MP1 issues an e-mail with respect to the e-mail address of the information of the member data D1.

Next, the present exemplified embodiments will be explained along various kinds of flowcharts.

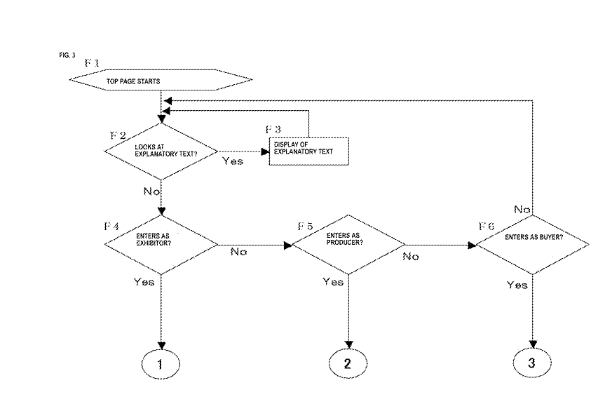

FIG. 3 is a flowchart relating to initial display.

A display process of the top page is performed in step F1. Next, judgment process of whether or not an explanatory text of the site utilization is displayed is performed in step F2.

In a case in which a browser selects browsing the explanatory text, a display process of the explanatory text of the site utilization is performed in step F3.

On the other hand, in a case in which the browser does not select browsing the explanatory text, the flow proceeds to a step of selecting to enter the website by which standpoint. With respect to this step, a judgment process of whether or not a login page for an exhibitor should be displayed is performed in step F4. Also, judgment process of whether or not a login page for a producer should be displayed is performed in step F5. Further, judgment process of whether or not a login page for a buyer should be displayed is performed in step F6.

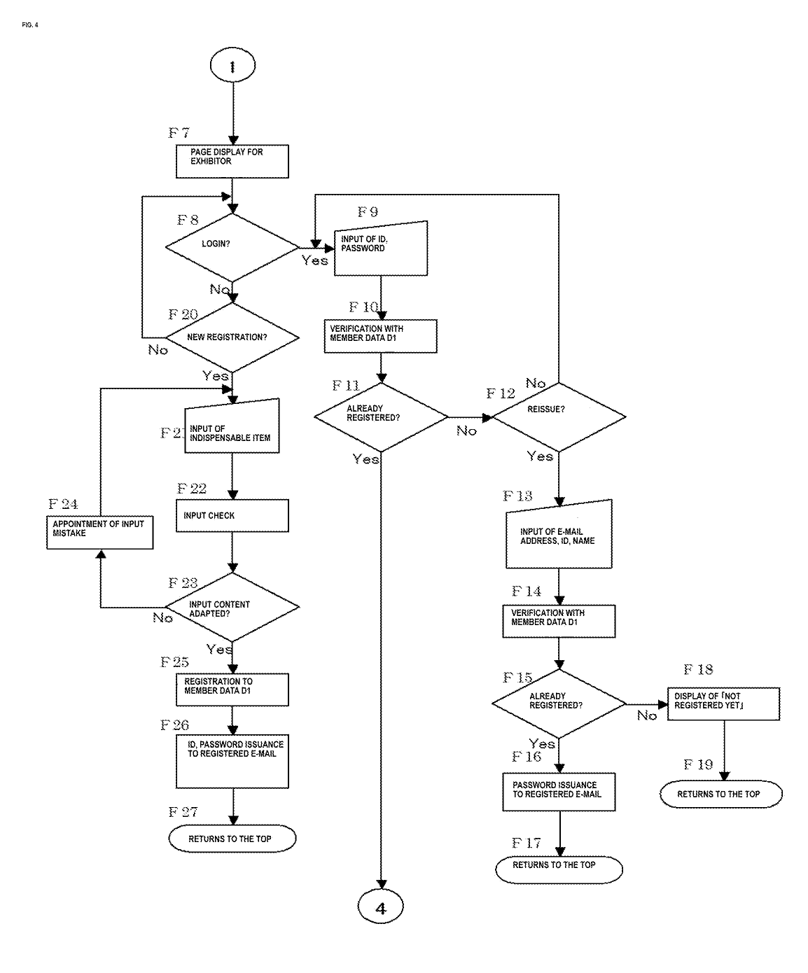

FIG. 4 is a flowchart relating to registration login for an exhibitor.

First, a display process for an exhibitor page is performed in step F7.

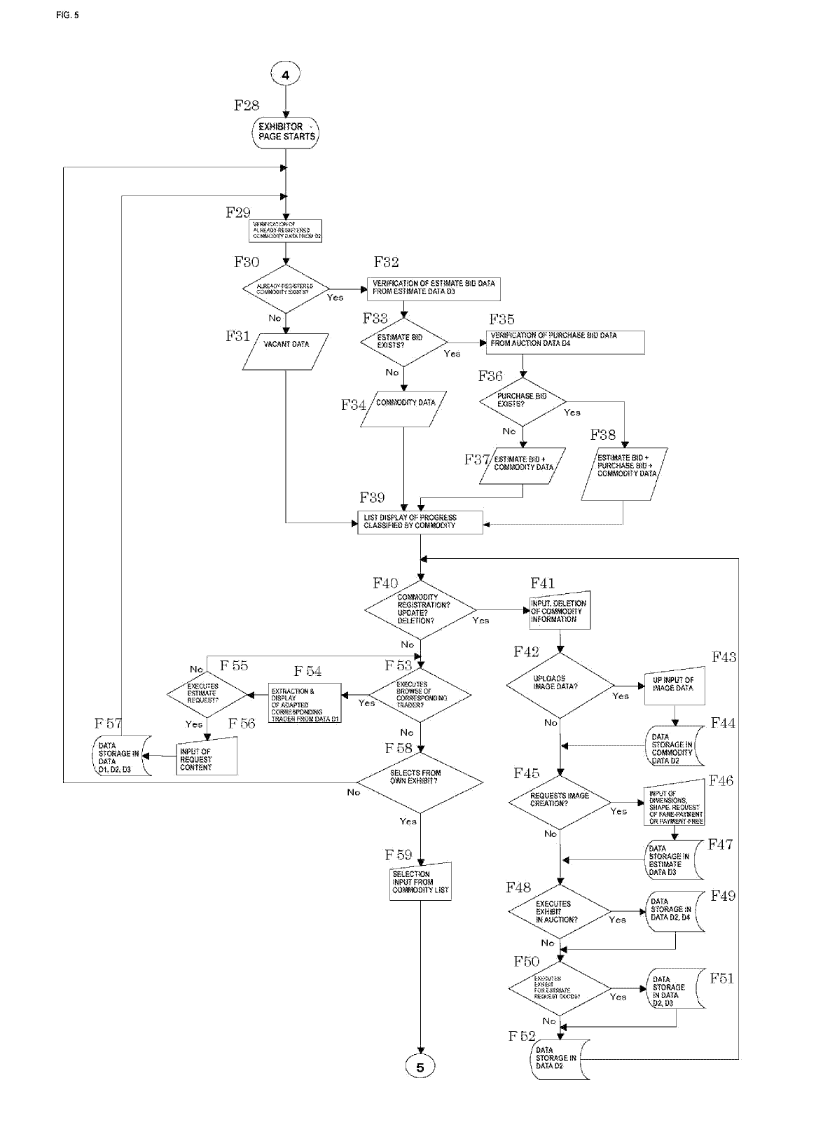

Next, a judgment process of whether or not the exhibitor logs in is performed in step F8 and in a case in which the exhibitor logs in, an input process of already-acquired ID and password is performed in step F9 and thereafter, a verification operation of the ID and the password inputted in step F9 with the data in the member data D1 is carried out in step F10, and a judgment process of whether or not there existed registration data as a result of step F10 is performed in step F11. In a case in which there exist registration data as a result of step F11, the flow proceeds to a flow of an exhibitor utilization page which will be explained in FIG. 5.

On the other hand, in a case in which there exist no registration data as a result of step F11, a judgment process of whether or not the ID and the password are desired to be reissued is performed in step F12.

In a case in which the reissuance is not desired in step F13, the flow returns to step F9.

On the other hand, in a case in which the reissuance is desired, an input process of the e-mail address, the ID and the name which are considered to be registered already is performed in step F13. After the input process, a verification operation of the e-mail address, the ID and the name inputted in step F13 with the data in the member data D1 is carried out in step F14. Next, a judgment process of whether or not there existed registration data as a result of step F14 is performed in step F15.

As a result of step F15, in a case in which there exist registration data, an e-mail shipping process of the password to the registration terminated e-mail address is performed in step F16 and a display process returning to step F1 is performed in step F17.

On the other hand, as a result of step F15, in a case in which there exist no registration data, a display process of characters, for example, ┌not registered yet┘ is performed in step F18 and a display process returning to step F1 is performed in step F19.

In a case in which the judgment process of whether or not the exhibitor logs in is performed and the exhibitor does not login in step F8, a judgment process of whether or not to execute new registration is performed in step F20. Next, an input process of an indispensable item of the new registration is performed in step F21, and an input omission diagnosis process of the indispensable item of the new registration is performed in step F22. A judgment process of whether or not there exists input omission is performed in step F23.

At that time, in a case in which there existed non-adaptation in the input result, a display process of the input mistake item is performed in step F24 and the flow returns to step F21.

On the other hand, in a case in which adaptation was the input result, the input information and the password of the new registration are allotted automatically and a saving process to the member data D1 is performed in step F25. Next, an e-mail shipping process of the password allotted automatically to the e-mail address of the new registration information in step F25 is performed in step F26, and a display process returning to step F1 is performed in step F27.

FIG. 5 is a flowchart relating to a utilization page for an exhibitor.

First, a display process of an exhibitor page form is performed in step F28. Next, in step F29, an automatic search process of existing information of the own commodity is performed from the commodity data D2, and in step F30, a judgment process of whether or not there exists existing information as a result of step F29 is performed.

In a case in which there exists no information as a result of step F30, a blank display process is performed in step F31.

On the other hand, in a case in which there exists information as a result of step F30, associated information is detected from the estimate data D3 and a verification process is performed in step F32 and as a result of step F32, a judgment process of whether or not there exists information coupled with the estimate data D3 is performed in step F33.

As a result of step F33, in a case in which there exists no information, a display process of the existing information of the own commodity is performed from the commodity data D2 in step F34.

On the other hand, in a case in which there exists information as a result of step F33, the associated information is detected from the auction data D4 and a verification process is performed in step F35, and as a result of step F35, a judgment process of whether or not there exists information coupled with the auction data D4 is performed in step F36.

In a case in which there exists no information as a result of step F36 in step F37, a display process of information coupled with the estimate data D3 is performed. On the other hand, in a case in which there exists information as a result of step F36, a display process of information coupled with the auction data D4 is performed in step F38.

A conversion and display process of the display data from step F31, step F34, step F37 and step F38 in a list form is performed in step F39.

Thereafter, a judgment process of whether or not to executed commodity registration, update or deletion is performed in step F40. In a case in which commodity registration, update or deletion is executed, an input process of instruction of commodity registration, update or deletion is performed in step F41 and a judgment process of whether or not to upload the image data is performed in step F42. Here, in case of uploading the image data, an input process of the image data upload is performed in step F43 and a data saving process for the commodity data D2 is performed in step F44.

Next, a judgment process of whether or not to request image creation is performed in step F45. Here, in case of requesting the image creation, an information input process of requesting the image creation is performed in step F46 and a data saving process for the estimate data D3 is performed in step F47.

Next, a judgment process of whether or not to execute exhibit in the auction is performed in step F48. Here, in case of executing exhibit in the auction, a process of saving the auction exhibit data in the commodity data D2 and the auction data D4 is performed in step F49.

Next, a judgment process of whether or not to execute the exhibit for the estimate request is performed in step F50. Here, in case of executing the exhibit for the estimate request, a process of saving the exhibit data for the estimate request in the commodity data D2 and the estimate data D3 is performed in step F51.

Next, a process of saving the registration information of the commodity only in the commodity data D2 is performed in step F52 and the flow returns to step F40.

In case of not carrying out registration, update of deletion of the commodity, a judgment process of whether or not the browse of the corresponding trader is executed is performed in step F53.

In case of carrying out the browse of the corresponding trader, in step F54, a process of list displaying corresponding traders classified by registered commodities is performed from the member data D1 and if there exists no registered commodity, a blank process is performed, and a judgment process of whether or not the estimate request is to be done for every trader is performed in step F55.

In case of not doing the estimate request, the flow returns to step F53.

On the other hand, in case of doing the estimate request, an input process of the estimate request content is performed in step F56, a process of saving the estimate request information in the member data D1, the commodity data D2 and the estimate data D3 is performed in step F57 and thereafter, the flow returns to step F29.

In case of not browsing the corresponding trader, a judgment process of whether or not the detail of the own exhibit commodity is inspected is performed in step F58. In case of not browsing the detail of the own exhibit commodity, the flow returns to step F29. On the other hand, in case of browsing the detail of the own exhibit commodity, selection and input process from the commodity list is performed in step F59.

According to this, it becomes possible to execute development of a production trader of a newly developed commodity and development of production cost estimate, selling price and a buyer concurrently and also speedily.

Also, with respect to the site of trades between companies and the auction site on the internet, it is possible according to the present exemplified embodiment to carry out also production and sales of newly developed commodities differently from a trade dealing only with existing commodities.

Further, in a general internet site which develops new commodities, participants only sell ideas and development of manufacturers or buyers are done by the site manager through negotiation, but it becomes also possible according to step F48 and step F50 of the present exemplified embodiment to achieve development of extensive manufacturers, general buyers or the like.

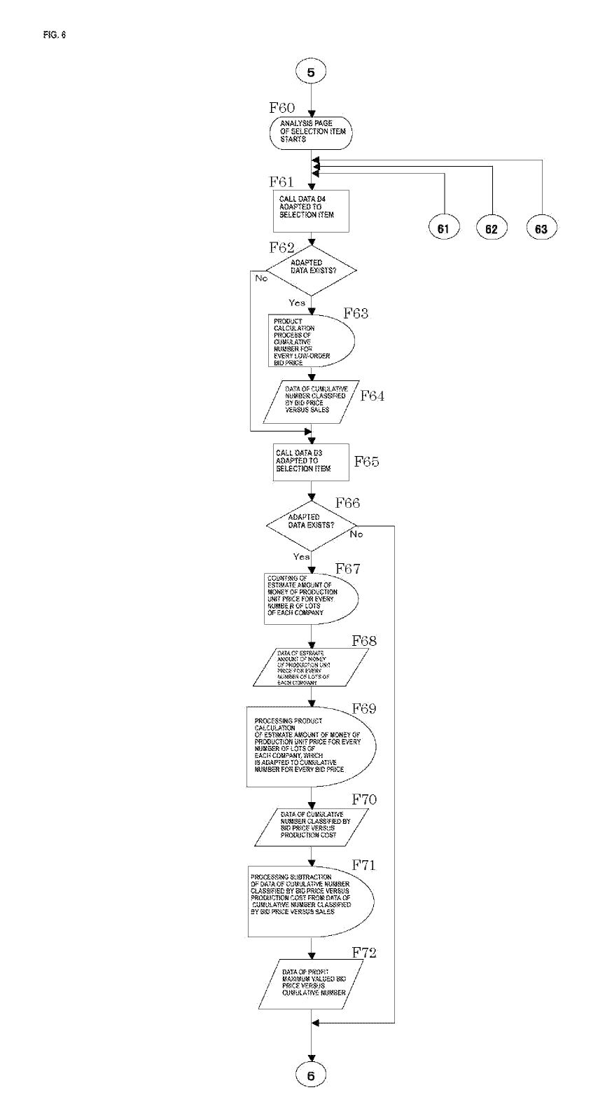

FIG. 6 is a flowchart relating to analysis of exhibitor selection items.

First, an initial setting process of selection item analysis is performed in step F60. Next, a detection process of data of auction data D4 associated with the selection item is performed in step F61, and a judgment process of whether or not there exist detected data is performed in step F62. In a case in which there exist detected data, the flow proceeds to step F65. On the other hand, in a case in which there exist no detected data, a product calculation process of cumulative number for every low-order bid price of the detected data is performed in step F63, and data of cumulative number classified by bid price versus sales which were created by the process of step F63 are obtained in step F64 and thereafter, the flow proceeds to step F65.

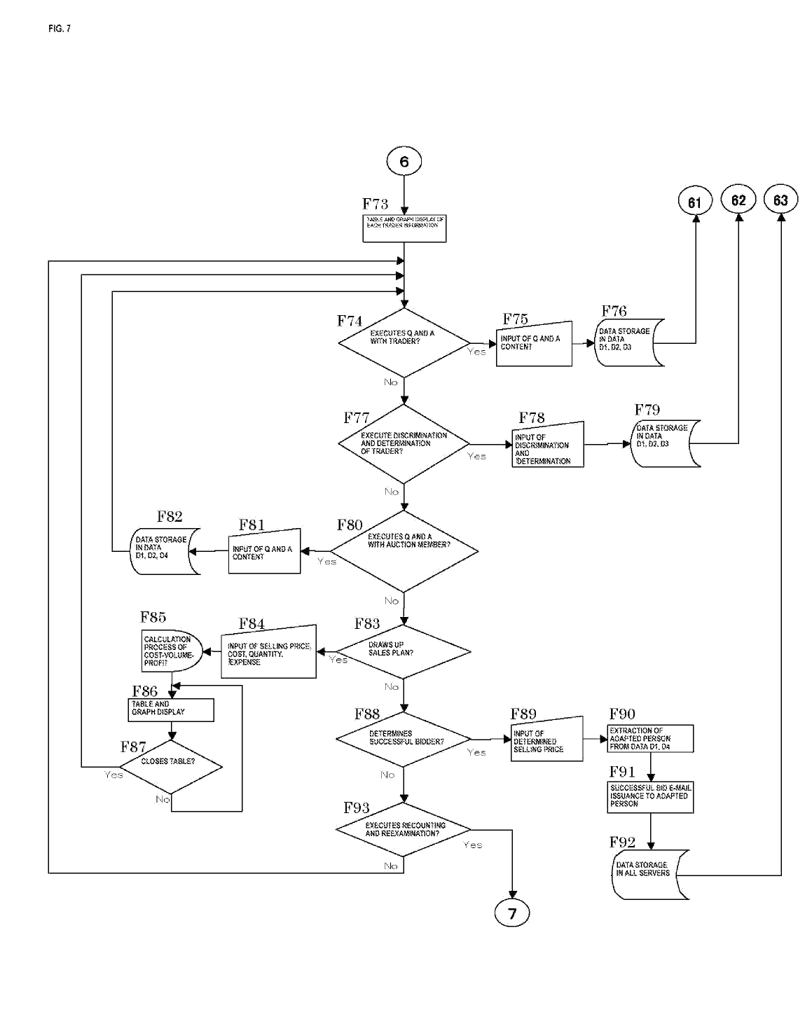

Next, a detection process of data of the estimate data D3 associated with the selection item is performed in step F65, and a judgment process of whether or not there exist detected data is performed in step F66. In a case in which there exist no detected data, the flow proceeds to a flow of selling price determination of an exhibitor, which will be explained in FIG. 7. On the other hand, in a case in which there exist detected data, a process of totaling estimate amount of money of production unit price for every number of lots of each company is performed in step F67, and data of estimate amount of money of production unit price for every number of lots of each company is inputted in step F68. Next, a product calculation process of estimate amount of money of production unit price for every number of lots of each company, which is adapted to cumulative number for every bid price is performed in step F69 and the result thereof is inputted to data of cumulative number classified by bid price versus production cost in step F70. Next, a process of subtracting the data of cumulative number classified by bid price versus production cost from the data of cumulative number classified by bid price versus sales is performed in step F71 and the result thereof is inputted to data of profit maximum valued bid price versus cumulative number in step F72.

There is cited, as drawbacks of a general internet business dealing system, a fact in which there are indwelled with a biased judgment by the interested parties such as commodity sales which do not satisfy the demand from the market, occurrence of stock excess based on excess productions, improperness of the selling price, improperness of the manufacturing cost and the like, but it becomes possible in the present exemplified embodiment to solve these drawbacks.

Also, even before the commodity plan is commercialized specifically, owing to a subtraction process of data of cumulative number classified by bid price versus sales obtained by processing product calculation of ┌cumulative number for every bid price┘ which is obtained by accumulating bid quantity for every low-order bid price sequentially from the maximum bid price of the auction information, and the corresponding bid price and estimate amount of money of production unit price for every number of lots adapted to aforesaid ┌cumulative number for every bid price┘ of the estimate information with respect to data of cumulative number classified by bid price versus production cost obtained by processing product calculation thereof and owing to a process of extracting bid price and cumulative number in which profit becomes the maximum value, accumulation for the prime cost, actual selling price and actual sales quantity can be judged accurately, so that the present exemplified embodiment can be utilized as a marketing function.

FIG. 7 is a flowchart relating to selling price determination of an exhibitor.

First, a process of list display and graph display of the data created in step F64, step F68, step F70 and step F72 is performed in step F73. Next, a judgment process of whether or not questions and answers (Q and A) with the trader are executed is performed in step F74.

The exhibitor and the designer of the commodity register commodity plans and by advertising for the production estimate request of these commodity plans depending on competitive bidding and by executing exhibition of these commodity plans to the auction, the matters will be recognized by internet users broadly, and as for the utility thereof, it becomes possible, according to step F74, to adopt opinions of production traders, purchase applicants, stock sales applicants, advertising agencies and the like as references and it becomes possible also to accomplish improvement and upgrading directed to more realizable commodification.

In a case in which Q and A with the trader are executed, a Q and A input process is performed in step F75 and a process of saving the Q and A content in the member data D1, the commodity data D2 and the estimate data D3 is performed in step F76 and thereafter, the flow returns to step F61.

On the other hand, in a case in which Q and A with the trader are not executed, a judgment process of whether or not discrimination of traders is executed is performed in step F77.

In a case in which discrimination of traders is executed, an input process of trader discrimination and determination is performed in step F78, a process of saving the content of the trader discrimination and determining in the member data D1, the commodity data D2 and the estimate data D3 is performed in step F79 and thereafter, the flow returns to step F62.

On the other hand, in a case in which the discrimination of traders is not executed, a judgment process of whether or not Q and A with an auction member are executed is performed in step F80.

In a case in which Q and A with an auction member are executed, an input process of the Q and A content is performed in step F81, a process of saving the Q and A content in the member data D1, the commodity data D2 and the estimate data D3 is performed in step F82 and thereafter, the flow returns to step F74.

On the other hand, in a case in which Q and A with an auction member are not executed, a judgment process of whether or not sales plan is drawn up is performed in step F83.

In case of drawing up a sales plan, an input process of selling price, manufacturing cost, quantity and expenses is performed in step F84, and a calculation process is performed by a cost-volume-profit calculation method in step F85. Next, a process of table and graph display of the values in step F85 is performed in step F86, and a judgment process of whether or not the table is closed is performed in step F87. Here, in case of closing the table, the flow returns to step F74 and in case of not closing the table, the flow returns to step F86.

On the other hand, in case of not drawing up a sales plan, a judgment process of whether or not a successful bidder is determined is performed in step F88.

In case of determining a successful bidder, an input process of a determined selling price is performed in step F89. Next, an extraction process of data adapted to the condition of step F89 from the data of the associated member data D1 and auction data D4 is performed in step F90, and shipping process of a notification e-mail of the successful bid to the e-mail address of the extracted data is performed in step F91. Next, a process of saving determination information of the commodity price and successful bid information in all the servers is performed in step F92 and the flow returns to step F63.

On the other hand, in case of not determining the successful bidder, a judgment process of whether or not recounting and reexamination of the selection item is executed is performed in step F93. Here, in case of executing recounting and reexamination of the selection item, the flow returns to step F7 and in case of not executing recounting and reexamination of the selection item, the flow returns to step F74.

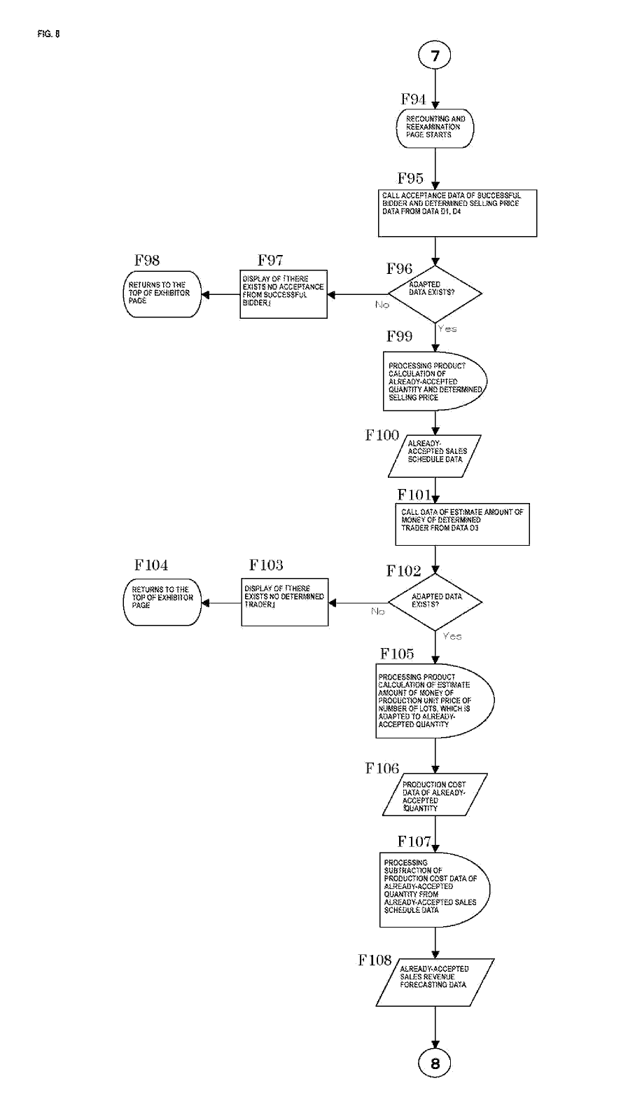

FIG. 8 is a flowchart relating to recounting and reexamination with respect to the commodity of the exhibitor.

First, an initial setting process of recounting and reexamination analysis of selection items is performed in step F94. Next, an extraction process of associated acceptance data of a successful bidder and determined selling price data is performed from the member data D1 and the auction data D4 in step F95, and a judgment process of whether or not there exist detected data is performed in step F96.

In a case in which there exist no detected data, a display process of ┌there exists no acceptance from successful bidder┘ is performed in step F97, and a display process returning to step F28 is performed in step F98.

On the other hand, in a case in which there exist detected data, a product calculation process of the already-accepted quantity and the determined selling price is performed in step F99, and the result thereof is inputted as already-accepted sales schedule data in step F100. Next, a data extraction process of an estimate amount of money of the associated determined trader is performed from the estimate data D3 in step F101, and a judgment process of whether or not there exist detected data is performed in step F102.

In a case in which there exist no detected data, a display process of ┌there exists no determined trader┘ is performed in step F103, and a display process returning to step F28 is performed in step F104.

On the other hand, in a case in which there exist detected data, a product calculation process of an estimate amount of money of production unit price of the number of lots, which is adapted to the already-accepted quantity is performed in step F105, and the result thereof is inputted as production cost data of already-accepted quantity in step F106. Next, a process of subtracting the production cost data of already-accepted quantity in step F106 from the already-accepted sales schedule data in step F100 is performed in step F107, and the result thereof is inputted as already-accepted sales revenue forecasting data in step F108.

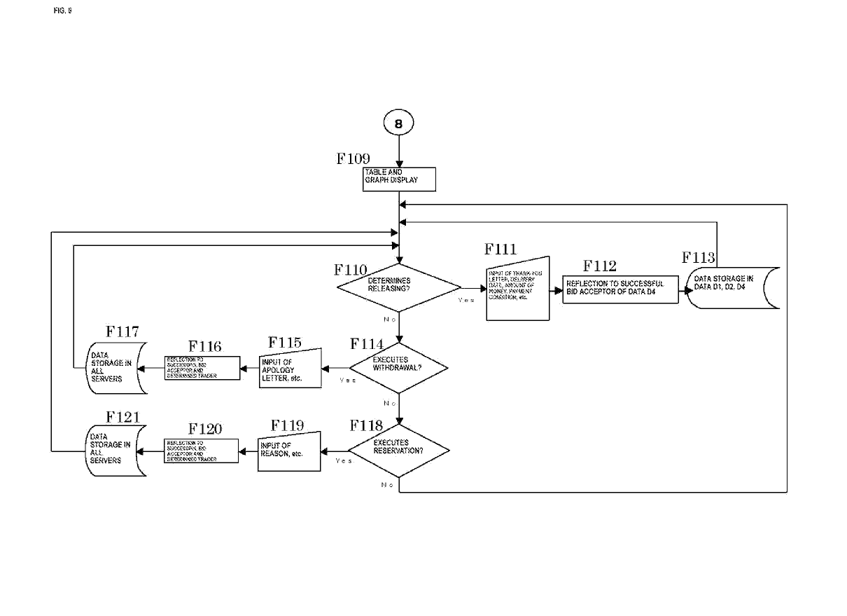

FIG. 9 is a flowchart relating to a final procedure of an exhibitor.

First, a process of list display and graph display of the data created in step F100, step F106 and step F108 is performed in step F109. Next, a judgment process of whether or not release is determined is performed in step F110.

In case of determining the release, an input process of thank-you letter, delivery date, amount of money, payment condition and the like is performed in step F111. Next, an information update process with respect to the successful bid acceptor of the auction data D4 is performed in step F112, and a process of saving the release information with respect to the member data D1, the commodity data D2 and the auction data D4 is performed in step F113. Thereafter, the flow returns to step F110.

On the other hand, in case of not determining the release judgment process of whether or not withdrawal is executed is performed in step F114.

In case of executing withdrawal, an input process of a withdrawal apology letter or the like is performed in step F115. Next, an information update process with respect to the successful bid acceptor of the auction data D4 and the determined trader of the estimate data D3 is performed in step F116, and a process of saving the withdrawal information in all the servers is performed in step F117. Thereafter, the flow returns to step F110.

On the other hand, in case of not executing withdrawal, a judgment process of whether or not reservation is executed is performed in step F118.

In case of executing reservation, an input process of its reason or the like is performed in step F119. Next, an information update process with respect to the successful bid acceptor of the auction data D4 and the determined trader of the estimate data D3 is performed in step F120, and a process of saving the reservation information in all the servers is performed in step F121. Thereafter, the flow returns to step F110.

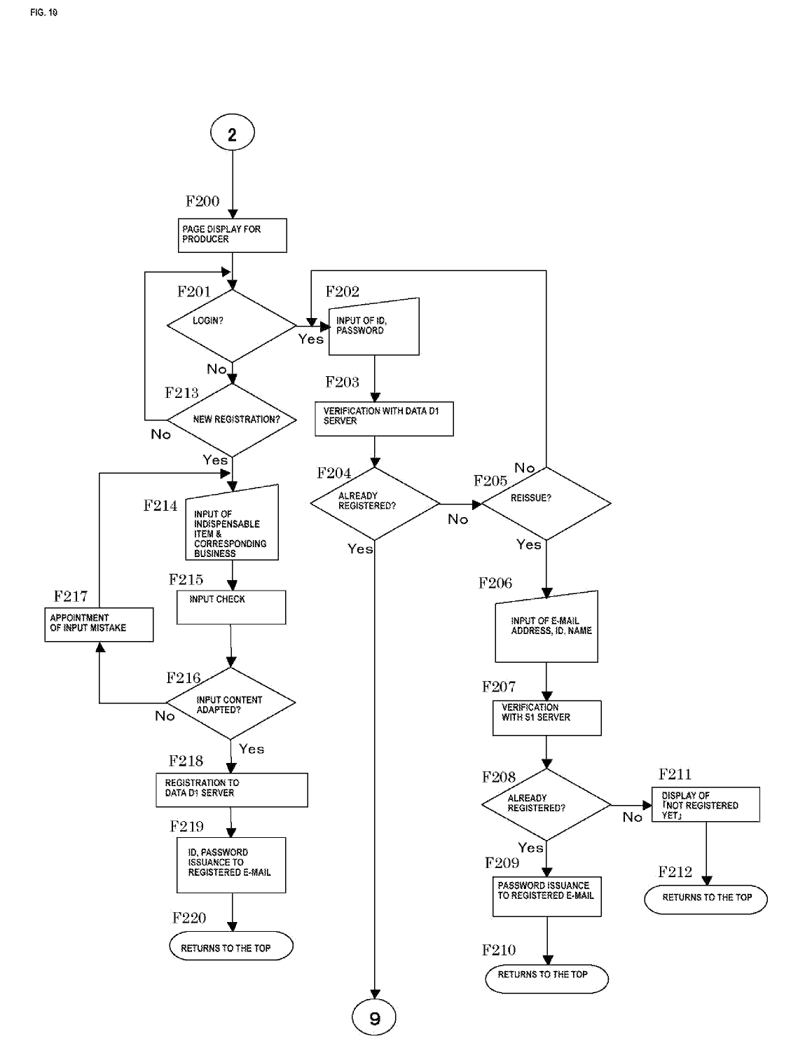

FIG. 10 is a flowchart relating to registration login for a producer.

First, a page display process for a producer is performed in step F200. Next, a judgment process of whether or not login is executed is performed in step F201.

In case of executing login, an input process of already-acquired ID and password is performed in step F202. Next, an operation of verifying the ID and the password inputted in step F202 with the data of the member data D1 is executed in step F203, and a judgment process of whether or not there existed registration data as a result of step F203 is performed in step F204.

In a case in which there exist no registration data, a judgment process of whether or not reissue is desired as a result of step F204 is performed in step F205.

In case of desiring reissue, an input process of the e-mail address, the ID and the name which are assumed to be registered already is performed in step F206. Next, an operation of verifying the e-mail address, the ID and the name inputted in step F206 with the data of the member data D1 is executed in step F207, and a judgment process of whether or not there existed registration data as a result of step F207 is performed in step F208.

In a case in which there existed registration data as a result of step F208, an e-mail shipping process of password to the registration terminated e-mail address is performed in step F209, and a display process returning to step F1 is performed in step F210.

On the other hand, in a case in which registration data did not exist as a result of step F208, a display process of characters ┌not registered yet┘ is performed in step F211, and a display process returning step F1 is performed in step F212.

In case of not executing login, a judgment process of whether or not new registration is executed is performed in step F213.

In case of not executing new registration, the flow returns to step F201.

On the other hand, in case of executing new registration, an input process of an indispensable item of new registration and content of corresponding business is performed in step F214. Next, a diagnosis process of input omission in the indispensable item of the new registration is performed in step F215, and a judgment process of whether or not there exists input omission is performed in step F216.

In a case in which the input content is not adapted, a display process of an input mistake item is performed in step F217, and the flow returns to step F214.

On the other hand, in a case in which the input content is adapted, the input information and the password of the new registration are allotted automatically and a process of saving them in the member data D1 is performed in step F218. Next, a process of e-mail shipping the password which was allotted automatically to the e-mail address of the new registration information in step F218 is performed in step F219, and a display process returning to step F1 is performed in step F220.

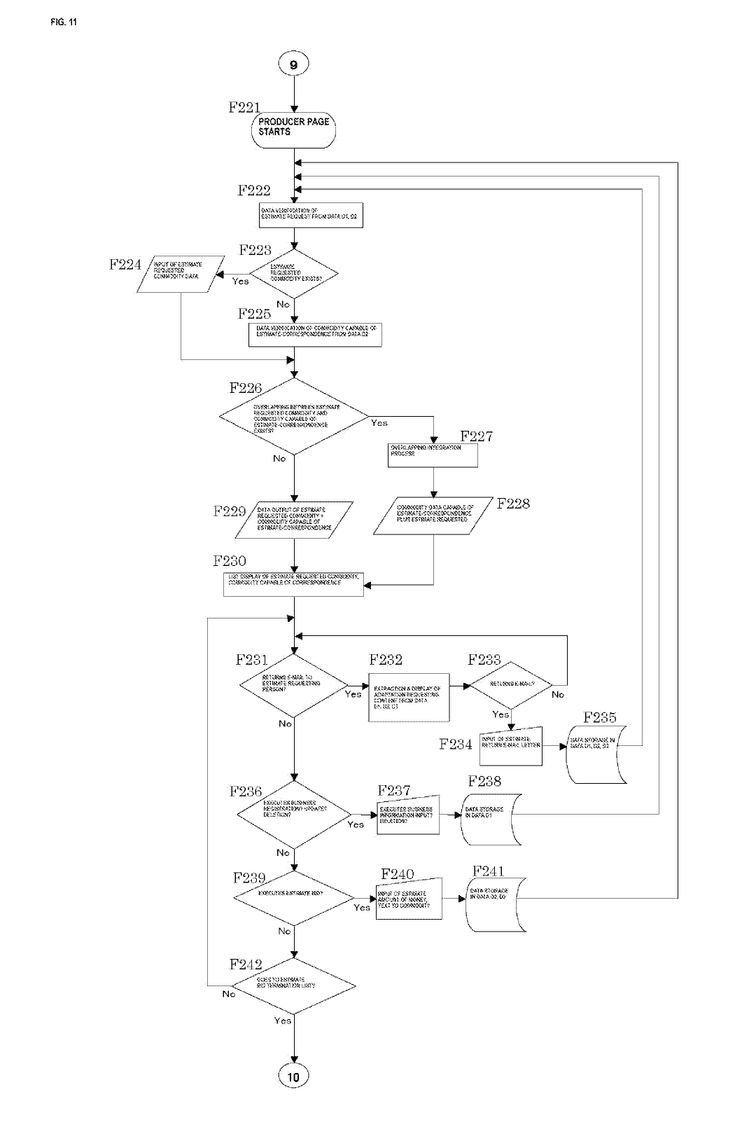

FIG. 11 is a flowchart relating to a utilization page for production.

First, a page display process for a producer is performed in step F221. Next, a detection process of estimate request information of commodity data D2 which are associated with business corresponding information of the member data D1 is performed in step F222. Next, a judgment process of whether or not there exists estimate requested commodity is performed in step F223.

In a case in which there exists the estimate requested commodity, input of the estimate requested commodity data is executed in step F224, and the flow proceeds to step F226.

On the other hand, in a case in which there exists no estimate requested commodity, a detection process of commodity data capable of estimate-correspondence from the commodity data D2 is performed in step F225.

Next, a judgment process of whether or not there exists overlapping between the estimate requested commodity and the commodity capable of estimate-correspondence is performed in step F226.

In a case in which there exists overlapping between the estimate requested commodity and the commodity capable of estimate-correspondence, an overlapping integration process between the estimate requested commodity and the commodity capable of estimate-correspondence is performed in step F227, and input of commodity data which are capable of estimate-correspondence plus estimate requested is executed in step F228 and thereafter, the flow proceeds to step F230.

On the other hand, in a case in which there exists no overlapping between the estimate requested commodity and the commodity capable of estimate-correspondence, an output of the estimate requested commodity data and the commodity data capable of estimate-correspondence is executed in step F229.

Next, a list display process of the commodity data capable of estimate-correspondence plus estimate requested in step F228 and estimate requested commodity data and commodity data capable of estimate-correspondence in F229 is performed in step F230. Thereafter, a judgment process of whether or not an e-mail is returned to the estimate requesting person is performed in F231.

In a case in which an e-mail is returned to the estimate requesting person in step F231, an extraction and display process of adaptation requesting content is performed from the associated member data D1, commodity data D2 and estimate data D3 in step F232, and a judgment process of whether or not an e-mail is returned to the requesting person is performed in step F233.

In a case in which an e-mail is not returned to the requesting person, the flow returns to step F231.

On the other hand, in a case in which an e-mail is returned to the requesting person, an input process of the estimate content and the return e-mail letter is performed in step F234. Next, a saving process in the member data D1, the commodity data D2 and the estimate data D3 is performed in step F235 and thereafter, the flow returns to step F222.

In a case in which an e-mail is not returned to the estimate requesting person in step F231, a judgment process of whether or not registration, update or deletion of business information is executed is performed in step F236.

In case of executing registration, update or deletion of the business information, an input process of an input or deletion instruction of the business information is performed in step F237. Next, an update and saving process in the member data D1 is performed in step F238 and thereafter, the flow returns to step F222.

On the other hand, in a case in which registration, update or deletion of the business information is not executed, a judgment process of whether or not an estimate request to the commodity displayed in step F230 is performed in step F239.

In case of executing estimate request, an input process of an estimate amount of money and a text is performed in step F240. Next, a process of saving data of the estimate amount of money and the text in the commodity data D2 and the estimate data D3 in step F241 and thereafter, the flow returns to step F222.

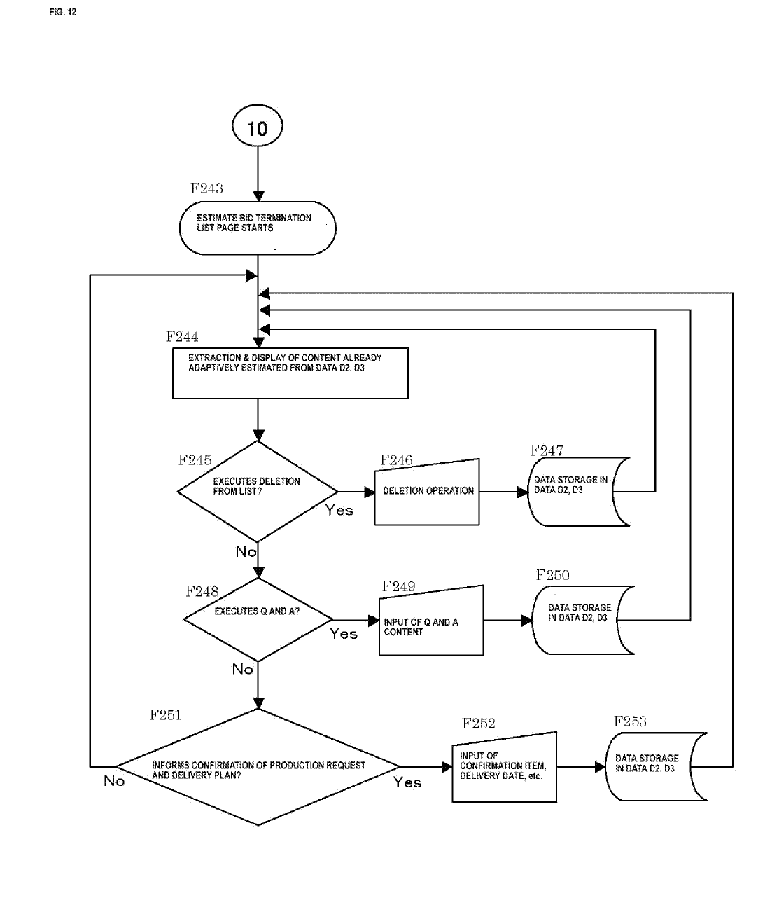

On the other hand, in case of not executing the estimate request, a judgment process of whether or not a display process of an estimate bid termination list is executed is performed in step F242. Here, in case of executing the display process of the estimate bid termination list, the flow proceeds to an estimate bid list of a producer and a final process flow, which will be explained in FIG. 12 and in case of not executing the display process of the estimate bid termination list, the flow returns to step F231.

According to step F230 and step F239 described above, it becomes always possible, for a person who can undertake business relating to production, to achieve development of new order receiving in his favorite subject by browsing estimate requested commodity plan of production, which is appropriate to own business ability and by applying for the competitive bid thereof.

FIG. 12 is a flowchart relating to an estimate bid list and a final process of a producer.

First, a list form display process of estimate bid termination is performed in step F243. Next, extraction and display of the associated estimation terminated content are executed from the commodity data D2 and the estimate data D3 in step F244. Next, a judgment process of whether or not deletion from the list is executed is performed in step F245.

In case of executing deletion from the list, an input process of deletion instruction is performed in step F246. Next, a process of saving the deleted information in the commodity data D2 and the estimate data D3 is performed in step F247 and thereafter, the flow returns to step F244.

On the other hand, in case of not executing deletion from the list, a judgment process of whether or not Q and A with the exhibitor are executed is performed in step F248.

By advertising for the production estimate request of these commodity plans depending on competitive bidding and by executing exhibition of these commodity plans to the auction, the commodity plans will be recognized by internet users broadly, and as for the utility thereof, it becomes possible, according to step F248, to adopt opinions of production traders, purchase applicants, stock sales applicants, advertising agencies and the like as references and it becomes possible also to accomplish improvement and upgrading directed to more realizable commodification.

In case of executing the Q and A with the exhibitor, an input process of the Q and A content with the exhibitor is performed in step F249. Next, a process of saving the Q and A information in the commodity data D2 and the estimate data D3 is performed in step F250 and thereafter, the flow returns to step F244.

On the other hand, in case of not executing the Q and A with the exhibitor, a judgment process of whether or not confirmation of the production request and a delivery plan are informed is performed in step F251.

In case of informing the confirmation of the production request and the delivery plan, an input process of a confirmation item and delivery date information is performed in step F252. Next, a process of saving the confirmation item and the delivery date information in the commodity data D2 and the estimate data D3 is performed in step F253 and thereafter, the flow returns to step F244.

On the other hand, in case of not informing the confirmation of the production request and the delivery plan, the flow returns to step F244.

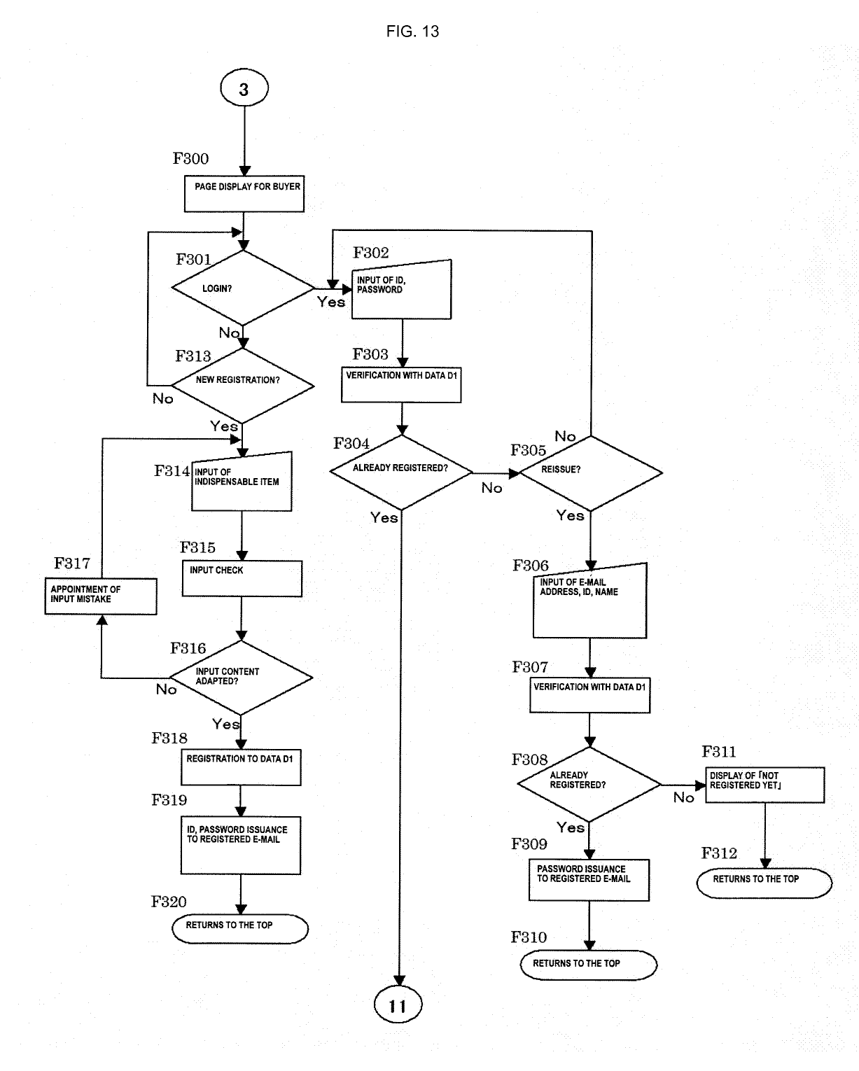

FIG. 13 is a flowchart relating to registration login for a buyer.

First, a page display process for a producer is performed in step F300. Next, a judgment process of whether or not login is executed is performed in step F301.

In case of executing login in step F301, an input process of the already-acquired ID and password is performed in step F302. Next, an operation of verifying the ID and the password inputted in step F302 with the data of the member data D1 is executed in step F303, and a judgment process of whether or not there existed registration data as a result of step F303 is performed in step F304.

In a case in which there exist no registration data as a result of step F304, a judgment process of whether or not reissue is desired is performed in step F305.

In case of not desiring reissue, the flow returns to step F302.

On the other hand, in case of desiring reissue, an input process of the e-mail address, the ID and the name which are considered to be registered already is performed in step F306. Next, an operation of verifying the e-mail address, the ID and the name inputted in step F306 with the data of the member data D1 is executed in step F307, and a judgment process of whether or not there existed registration data as a result of step F307 is performed in step F308.

In a case in which there existed registration data as a result of step F308, an e-mail shipping process of password to the registration terminated e-mail address is performed in step F309, and a display process returning to step F1 is performed in step F310.

On the other hand, in a case in which registration data did not exist as a result of step F308, a display process of characters ┌not registered yet┘ is performed in step F311, and a display process returning step F1 is performed in step F312.

In case of not executing login in step F301, a judgment process of whether or not to execute new registration is performed in step F313.

In case of not executing new registration, the flow returns to step F301.

On the other hand, in case of executing new registration, an input process of an indispensable item of the new registration is performed in step F314. Next, a diagnosis process of input omission in the indispensable item of the new registration is performed in step F315, and a judgment process of whether or not there exists input omission is performed in step F316.

In a case in which the input content is non-adapted, a display process of an input mistake item is performed in step F317, and the flow returns to step F314.

On the other hand, in a case in which the input content is adapted, the input information and the password of the new registration are allotted automatically and a process of saving them in the member data D1 is performed in step F318. Next, a process of e-mail shipping the password which was allotted automatically to the e-mail address of the new registration information in step F318 is performed in step F319 and thereafter, a display process returning to step F1 is performed in step F320.

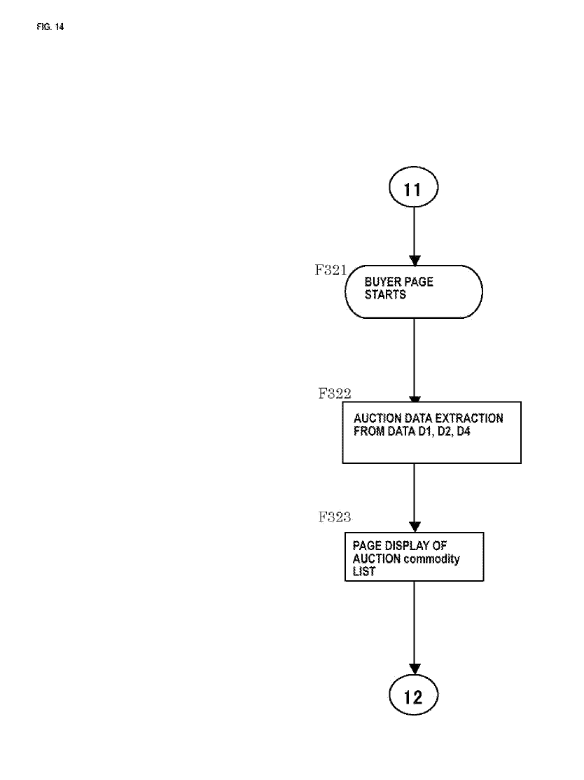

FIG. 14 is a flowchart relating to an auction page for a buyer.

First, a display process of an auction page form for a buyer is performed in step F321. Next, in step F322, an extraction process of auction data is performed by being associated with the data from the member data D1, the commodity data D2 and the auction data D4. Next, a page display process of an auction commodity list is performed in step F323.

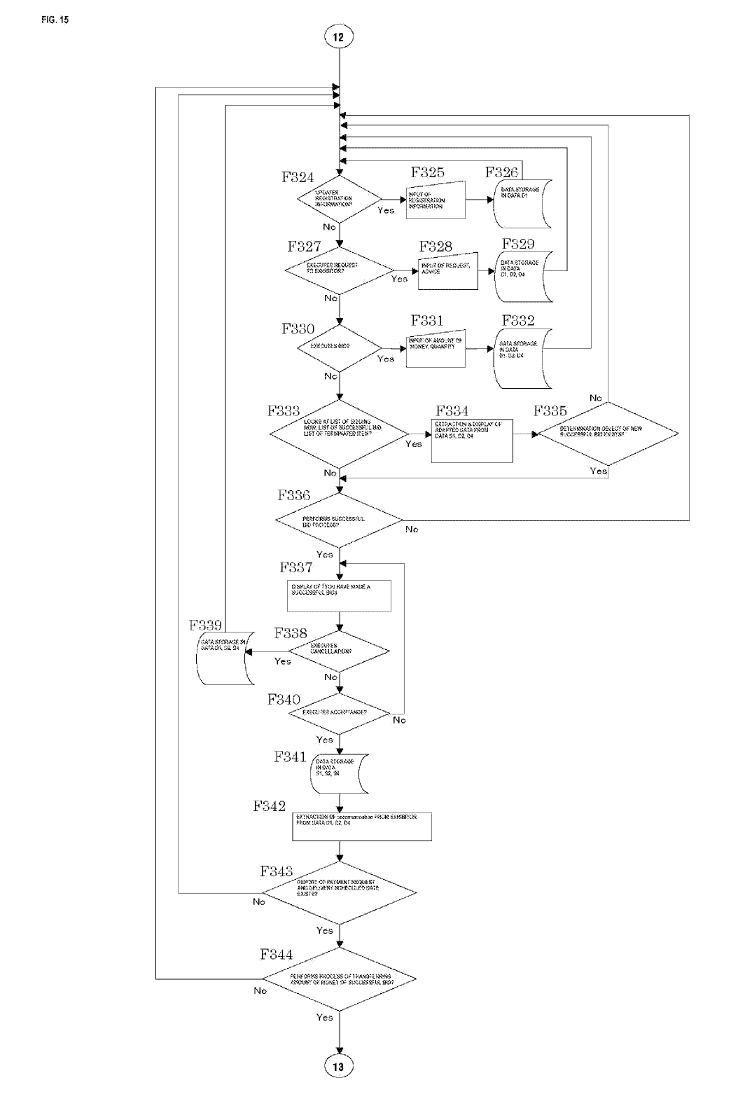

FIG. 15 is a flowchart relating to auction participation of a buyer.

First, a judgment process of whether or not to update the registration information is performed in step F324.

In case of updating the registration information, a report input process of the registration information is performed in step F325. Next, a process of saving update information in the member data D1 is performed in step F326 and thereafter, the flow returns to step F324.

On the other hand, in case of not updating the registration information, a judgment process of whether or not to execute a request to the exhibitor is performed in step F327. In other words, it is possible for the auction participants to propose demands of specification, design and the like with respect to the new commodity plan.

The exhibitor and the designer of the commodity register commodity plans and by advertising for the production estimate request of these commodity plans depending on competitive bidding and by executing exhibition of these commodity plans to the auction, the matters will be recognized by internet users broadly, and as for the utility thereof, it becomes possible, according to step F327, to adopt opinions of production traders, purchase applicants, stock sales applicants, advertising agencies and the like as references and it becomes possible also to accomplish improvement and upgrading directed to more realizable commodification.

In case of not executing a request to the exhibitor, a process of inputting request and advice information to the exhibitor is performed in step F328. Next, a process of saving the request and advice information in the commodity data D2 and the auction data D4 by being associated with the member data D1 is performed in step F329 and thereafter, the flow returns to step F324.

On the other hand, in case of executing a request to the exhibitor, a judgment process of whether or not to execute a bid is performed in step F330.

In case of executing a bid, an input process of the amount of money and quantity is performed in step F331. Next, a process of saving information of the amount of money and quantity in the commodity data D2 and the auction data D4 by being associated with the data of the member data D1 is performed in step F332 and thereafter, the flow returns to step F324.

On the other hand, in case of not executing the bid, in step F333, a judgment process of whether or not to look at a list of bidding now, successful bids and terminated items is performed.

In case of looking at the list of bidding now, successful bids and terminated items, an extraction and display process of data of bidding now, successful bids and terminated items of the commodity data D2 and the auction data D4, which are associated with the data of the member data D1 is performed in step F334. Next, a judgment process of whether or not there exists a determination object of a new successful bid is performed in step F335 and thereafter, the flow returns to step F324.

On the other hand, in case of not looking at the list of bidding now, successful bids and terminated items, a judgment process of whether or not to perform a successful bid process from the successful bid item is performed in step F336.

In case of not performing a successful bid process, the flow returns to step F324.

On the other hand, in case of performing a successful bid process, a process of displaying a text ┌you have made a successful bid┘ is performed in step F337. Next, a judgment process of whether or not to execute cancellation is performed in step F338.

In case of executing cancellation, a process of saving the cancellation information in the commodity data D2 and the auction data D4 by being associated with the data of the member data D1 is performed in step F339 and thereafter, the flow returns to step F324.

On the other hand, in case of not executing cancellation, a judgment process of whether or not to execute acceptance is performed in step F340.

In case of not executing acceptance, the flow returns to step F337.

On the other hand, in case of executing acceptance, a process of saving the acceptance information in the commodity data D2 and the auction data D4 by being associated with the data of the member data D1 is performed in step F341. Next, an extraction and display process of communication information from the exhibitors of the commodity data D2 and the auction data D4, which are associated with the data of the member data D1 is performed in step F342. Next, a judgment process of whether or not there exists report information of payment request and delivery scheduled date from the exhibitor is performed in step F343.

In a case in which there exists no report information of payment request and delivery scheduled date from the exhibitor, the flow returns to step F324.

On the other hand, in a case in which there exists report information of payment request and delivery scheduled date from the exhibitor, a judgment process of whether or not to transfer the amount of money of the successful bid is performed in step F344.

In case of not transferring the amount of money of the successful bid, the flow returns to step F324.

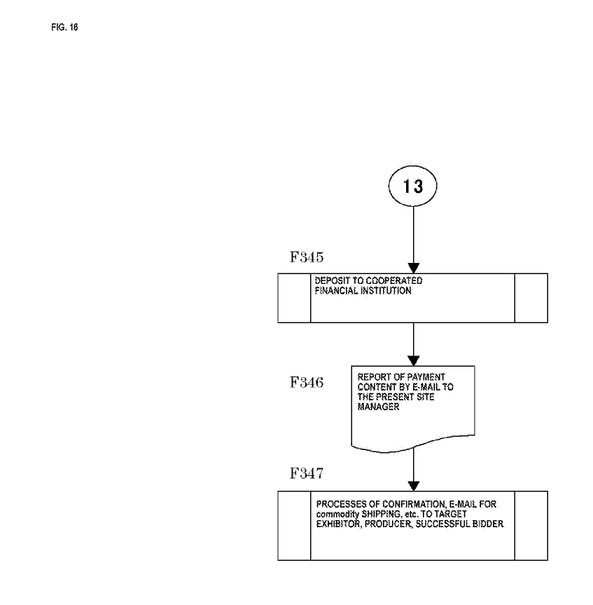

On the other hand, in case of transferring the amount of money of the successful bid, the flow proceeds to a flow of a process of transferring the successful bid charge of a buyer, which will be explained in FIG. 16.

Thereby, a person adapted to the auction successful bid who has a desire of purchasing the commodity can get the new commodity within his desired price concurrently with the release thereof.

FIG. 16 is a flowchart relating to a transferring process of the successful bid charge of a buyer.

First, a link returning process to the cooperated financial institution end for processing deposit to the cooperated financial institution according to a processing method of the cooperated financial institution is performed in step F345. Next, a receiving process of confirming that payment information was sent by the cooperated financial institution to the e-mail address of the present site manager is performed in step F346. Next, a notifying process for disclosing payer information to the commodity exhibitor and producer of the payment object and for carrying out shipment instruction of the commodity through the server and the e-mail and an e-mail shipping process for confirming payment acceptance directed to the payer are performed in step F347.

Thereby, it is possible for a person who can undertake business relating to the commodity designer and the production to prevent an unpaid risk of the commodity charge by a fact that persons who determined the purchase execute prepayment deposit of the purchasing money to the cooperated financial institution of the present site when practicing the manufacturing and the sales.

Also, if there exists promise violation for the buyers when delivering the commodity, it is possible to prevent an undelivery risk by asking the cooperated financial institution of the present site for the refund of the purchasing money which was deposited by prepayment.

Next, the present exemplified embodiment will be explained along operation procedures of the WEB site page.

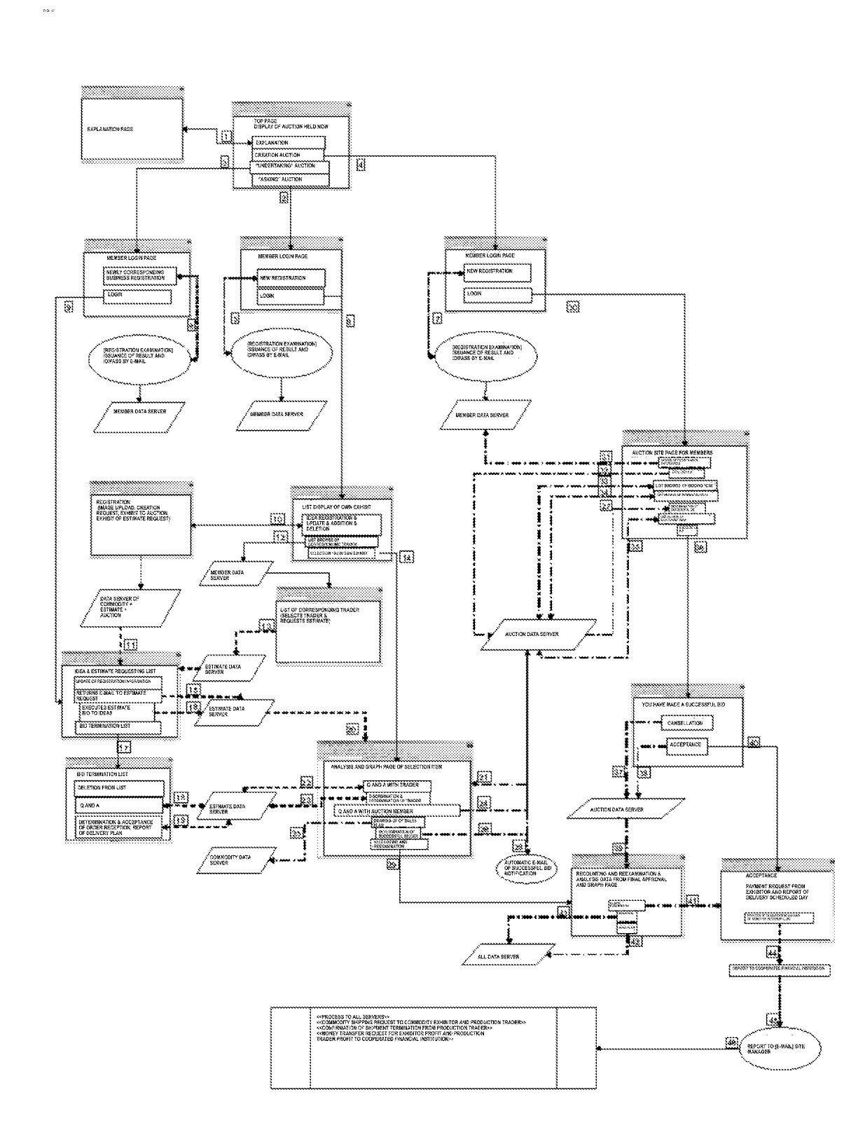

FIG. 17 is a diagram showing one example of the operation procedures of the WEB site page.

In the top page, a user reaches an ┌explanation page of site utilization┘ depending on a explanation button in order to understand the handling method of the present site (1). A commodity designer reaches a ┌member login page┘ for the “asking” market depending on an “asking” market button of the ┌top page┘ (2). A person who undertakes commercialization reaches a ┌member login page┘ for the “undertaking” market depending on an “undertaking” market button of the ┌top page┘ (3). A commodity purchase applicant reaches a ┌member login page┘ for the creation auction depending on a creation auction button of the ┌top page┘ (4).

In the ┌member login page┘ for the “asking” market, with respect to a new registration of the ┌member login page┘ for the “asking” market, the result of the registration examination and the ID/Pass are sent back by e-mail to the person to be registered and the information is sent to the member data server (5). Also, an ┌own exhibit list page┘ is reached by executing login from the ┌member login page┘ for the “asking” market (8).

In the ┌member login page┘ for the “undertaking” market, with respect to a new registration of the ┌member login page┘ for the “undertaking” market, the result of the registration examination and the ID/Pass are sent back by e-mail to the person to be registered and the information is sent to the member data server (6). Also, an ┌idea-estimate requesting list page┘ is reached by executing login from the ┌member login page┘ for the “undertaking” market (9).

In the ┌member login page┘ for the creation auction for the creation auction, with respect to a new registration of the ┌member login page┘, the result of the registration examination and the ID/Pass are sent back by e-mail to a person to be registered and the information is sent to the member data server (7). Also, an ┌auction site page for the members┘ is reached by executing login from the ┌member login page┘ for the creation auction (30).

In an ┌own exhibit list page┘, the commodity designer reaches a ┌registration page┘ depending on an idea registration-update-addition-deletion button of the ┌own exhibit list page┘ (10). Also, the commodity designer reaches a page of a ┌corresponding trader list┘ extracted from the member data server depending on a corresponding trader list browsing button of the ┌own exhibit list page┘ (12). Further, the commodity designer reaches an ┌analysis data and graph page of selection item┘ depending on a selection button from the own exhibit of the ┌own exhibit list page┘ (14).

In the page of ┌corresponding trader list┘, the commodity designer selects a trader from the ┌corresponding trader list┘ and executes an estimate request (13). These data are transmitted to the estimate data server.

In the ┌registration page┘, the resisted-updated-added-deleted data of the idea are transmitted to the commodity data server and the data thereof are reflected to the ┌idea-estimate requesting list page┘ for the person who undertakes the commercialization thereof (11).

In the ┌idea-estimate requesting list page┘, a person who undertakes the commercialization sends a return e-mail to the estimate requesting person from the ┌idea-estimate requesting list page┘ (15). These data are transmitted to the estimate data server.

Also, a person who undertakes the commercialization executes an estimate bid with respect to the idea of the commodity designer from the ┌idea-estimate requesting list page┘ (16). These data are transmitted to the estimate data server. The estimate data from the person who undertakes the commercialization, which are accumulated in real time are reflected to the ┌analysis data and graph page of selection item┘ of the commodity designer from the estimate data server (20). Further, a person who undertakes the commercialization reaches a bid termination list depending on a button of the bid termination list of the ┌idea-estimate requesting list page┘ (17).

In a ┌bid termination list page┘, a person who undertakes the commercialization executes Q and A with the commodity designer of the “asking” market from the ┌bid termination list page┘ (18). These data are transmitted to the estimate data server. Also, order confirmation and a report of acceptance-delivery plan are executed with the commodity designer of the “asking” market from the ┌bid termination list page┘ (19). These data are transmitted to the estimate data server.

In the ┌analysis data and graph page of selection item┘, Q and A are executed with the person who undertakes the commercialization of the “undertaking” market (22). These data are transmitted to the estimate data server. Also, discrimination and determination of the person who undertakes the commercialization are executed (23). These data are transmitted to the estimate data server. Also, drawing up of the sales plan is executed (25). These data are transmitted to the commodity data server. Also, Q and A are executed with the commodity purchase applicant of the creation auction (24). These data are transmitted to the auction data server. Also, a successful bidder of the commodity purchase is determined (26). These data are transmitted to the auction data server. When the commodity designer executes determination of the successful bidder, the notification of the successful bid is sent to the successful bidder of the commodity purchase by means of an automatic e-mail program (28). Also, the commodity designer reaches ┌data and graph page of recounting and reexamination-analysis from the final acceptance┘ depending on a recounting and reexamination button of the ┌analysis data and graph page of selection item┘ (29). It should be noted that the auction data from the commodity purchase applicant, which are accumulated in real time are reflected to the ┌analysis data and graph page of selection item┘ of the commodity designer from the auction data server (21).

In an ┌auction site page for members┘, the registration information updated data of the ┌auction site page for members┘ of the commodity purchase applicant are transmitted to the member data server (31). Also, data that the commodity purchase applicant executed a bid are transmitted to the auction data server (32). Also, a commodity purchase applicant enters a successful bid process depending on a successful bid button of the ┌auction site page for members┘ (36). It should be noted that the commodity purchase applicant is browsing the list of bidding now, so that lists are extracted from the auction data server (33). Also, the commodity purchase applicant is browsing the terminated item list, so that lists are extracted from the auction data server (34). Also, when the successful bid determination from the commodity designer is executed, data display of the successful bid determination is carried out from the auction data server (27). Also, the commodity purchase applicant is browsing the successful bid list, so that lists are extracted from the auction data server (35).

In a case in which the commodity purchase applicant cancels the successful bid commodity, the cancellation data are transmitted to the auction data server (37). On the other hand, in a case in which the commodity purchase applicant accepts the successful bid, the acceptance data are transmitted to the auction data server (38). After the acceptance of the successful bid, the commodity purchase applicant performs a process of transferring the amount of money of the successful bid (40).

In the ┌data and graph page of recounting and reexamination-analysis from the final acceptance┘, receiving the acceptance or cancellation of the successful bid of the commodity purchase applicant, tabulation of cancellation or acceptance data of the successful bidder is displayed from the auction data server to the commodity designer (39). In a case in which the commodity designer withdraws the release, the withdrawal data are transmitted to the commodity data server and the auction data server (42). On the other hand, in a case in which the commodity designer reserves the release, the release reservation data are transmitted to the commodity data server and the auction data server (43). Also, in case of release determination by the commodity designer, that effect is displayed onto the picture screen of the successful bid acceptor (41). Next, the successful bidder transfers the amount of money of the successful bid to the cooperated financial institution (44). The report of the payment from the successful bidder is informed by e-mail from the cooperated financial institution to the site manager (45). The site manager executes the final process to all the servers and the commodity shipping request with respect to the commodity exhibitor and the production trader and thereafter, requests the cooperated financial institution to transfer money for the exhibitor profit and the production trader profit as a result of the confirmation of the shipment termination from the production trader (46).

TABLE 1
*Primary data: cumulative number for every bid price (bid quantity was accumulated
for every low-order bid price sequentially from maximum bid price)

bid price

| | ¥100 | ¥90 | ¥80 | ¥70 | ¥60 | ¥50 | ¥40 | ¥30 | ¥20 | ¥10 |
|---|---|---|---|---|---|---|---|---|---|---|
| number of | 3 | 5 | 8 | 15 | 25 | 50 | 40 | 35 | 50 | 98 |
| bids | | | | | | | | | | |
| cumulative | 3 | 8 | 16 | 31 | 56 | 106 | 146 | 181 | 231 | 329 |
| quantity | | | | | | | | | | |

*Primary data: estimate bid result of each trader

| | number of lots | | | | | | | | | | | |
|---|---|---|---|---|---|---|---|---|---|---|---|---|
| | | within | within | within | within | within | within | within | within | within | within | within |
| | within 5 | 10 | 20 | 30 | 40 | 50 | 60 | 70 | 80 | 90 | 100 | 150 |
| (A-Company) | ¥60 | ¥55 | ¥50 | ¥45 | ¥40 | ¥35 | ¥30 | ¥30 | ¥30 | ¥30 | ¥30 | ¥25 |
| unit price | | | | | | | | | | | | |
| classified by | | | | | | | | | | | | |
| lot | | | | | | | | | | | | |
| (B-Company) | ¥80 | ¥75 | ¥65 | ¥55 | ¥45 | ¥35 | ¥25 | ¥25 | ¥25 | ¥25 | ¥25 | ¥25 |
| unit price | | | | | | | | | | | | |
| classified by | | | | | | | | | | | | |
| lot | | | | | | | | | | | | |
| (C-Company) | ¥65 | ¥55 | ¥50 | ¥45 | ¥40 | ¥35 | ¥30 | ¥30 | ¥30 | ¥25 | ¥25 | ¥20 |
| unit price | | | | | | | | | | | | |
| classified by | | | | | | | | | | | | |
| lot | | | | | | | | | | | | |
| (D-Company) | ¥80 | ¥70 | ¥60 | ¥50 | ¥40 | ¥30 | ¥20 | ¥20 | ¥20 | ¥20 | ¥20 | ¥20 |
| unit price | | | | | | | | | | | | |
| classified by | | | | | | | | | | | | |
| lot | | | | | | | | | | | | |
| (E-Company) | ¥90 | ¥85 | ¥80 | ¥70 | ¥60 | ¥50 | ¥50 | ¥40 | ¥40 | ¥30 | ¥30 | ¥20 |
| unit price | | | | | | | | | | | | |
| classified by | | | | | | | | | | | | |
| lot | | | | | | | | | | | | |

*Secondary data: cumulative number classified by bid price (bid quantity was
accumulated for every low-order bid price sequentially from maximum bid price)

| | bid price | | | | | | | | | |
|---|---|---|---|---|---|---|---|---|---|---|
| | ¥100 | ¥90 | ¥80 | ¥70 | ¥60 | ¥50 | ¥40 | ¥30 | ¥20 | ¥10 |
| cumulative | ¥300 | ¥720 | ¥1,280 | ¥2,170 | ¥3,360 | ¥5,300 | ¥5,840 | ¥5,430 | ¥4,620 | ¥3,920 |
| quantity vs | | | | | | | | | | |
| sales | | | | | | | | | | |

*Secondary data: data of cumulative number classified by bid price versus production
cost (cumulative number for every “bid price” × “production unit price of number of
lots corresponding to cumulative number for every bid price”

| | bid price | | | | | | | | | |
|---|---|---|---|---|---|---|---|---|---|---|
| | ¥100 | ¥90 | ¥80 | ¥70 | ¥60 | ¥50 | ¥40 | ¥30 | ¥20 | ¥10 |
| (A-Company) | ¥180 | ¥440 | ¥800 | ¥1,240 | ¥1,680 | ¥2,650 | ¥3,650 | ¥3,620 | ¥4,158 | ¥5,593 |
| production cost | | | | | | | | | | |
| (B-Company) | ¥240 | ¥600 | ¥1,040 | ¥1,395 | ¥1,400 | ¥2,650 | ¥3,650 | ¥4,525 | ¥4,620 | ¥5,922 |
| production cost | | | | | | | | | | |
| (C-Company) | ¥195 | ¥440 | ¥800 | ¥1,240 | ¥1,680 | ¥2,120 | ¥2,920 | ¥3,620 | ¥4,389 | ¥5,593 |
| production cost | | | | | | | | | | |
| (D-Company) | ¥240 | ¥560 | ¥960 | ¥1,240 | ¥1,120 | ¥2,120 | ¥2,920 | ¥3,620 | ¥4,158 | ¥5,264 |
| production cost | | | | | | | | | | |
| (E-Company) | ¥270 | ¥680 | ¥1,280 | ¥1,860 | ¥2,800 | ¥2,120 | ¥2,920 | ¥2,715 | ¥3,465 | ¥4,935 |
| production cost | | | | | | | | | | |

*Tertiary data: table of cumulative number versus sales profit & loss (“data of
cumulative number classified by bid price versus sales” − “data of cumulative number
classified by bid price versus production cost”

| | bid price | | | | | | | | | |
|---|---|---|---|---|---|---|---|---|---|---|
| | ¥100 | ¥90 | ¥80 | ¥70 | ¥60 | ¥50 | ¥40 | ¥30 | ¥20 | ¥10 |
| cumulative | ¥300 | ¥720 | ¥1,280 | ¥2,170 | ¥3,360 | ¥5,300 | ¥5,840 | ¥5,430 | ¥4,620 | ¥3,920 |
| quantity vs | | | | | | | | | | |
| sales | | | | | | | | | | |
| (A-Company) | ¥120 | ¥280 | ¥480 | ¥930 | ¥1,680 | ¥2,650 | ¥2,190 | ¥1,810 | ¥462 | −¥2,303 |
| profit or loss | | | | | | | | | | |
| (B-Company) | ¥60 | ¥120 | ¥240 | ¥775 | ¥1,960 | ¥2,650 | ¥2,190 | ¥905 | ¥0 | −¥2,632 |
| profit or loss | | | | | | | | | | |
| (C-Company) | ¥105 | ¥280 | ¥480 | ¥930 | ¥1,680 | ¥3,180 | ¥2,920 | ¥1,810 | ¥231 | −¥2,303 |
| profit or loss | | | | | | | | | | |
| (D-Company) | ¥60 | ¥160 | ¥320 | ¥930 | ¥2,240 | ¥3,180 | ¥2,920 | ¥1,810 | ¥462 | −¥1,974 |
| profit or loss | | | | | | | | | | |
| (E-Company) | ¥30 | ¥40 | ¥0 | ¥310 | ¥560 | ¥3,180 | ¥2,920 | ¥2,715 | ¥1,155 | −¥1,645 |
| profit or loss | | | | | | | | | | |

The table 1 is a table showing one example wherein data of the commodity selected in a case in which an exhibitor makes release determination of the commodity are processed by totaling calculation.

First, cumulative number for every bid price and estimate bid result of each trader are tabularized for the primary data. Here, the cumulative number for every bid price is quantity in which, for example, bid quantity corresponding to the price range (bid price) by which the buyer wants to execute the bid is accumulated for every bid price sequentially from the maximum bid price to low-order bid price. Also, the estimate bid result of each trader is a result in which the unit price classified by lot is made to have correspondence with the number of lots when tentatively supposing that each trader is to execute realization of the commodity or the like.

Next, data of cumulative number classified by bid price versus sales and data of cumulative number classified by bid price versus production cost are tabularized for the secondary data. Here, the data of cumulative number classified by bid price versus sales are data of multiplying the bid price by the cumulative number for every bid price in the primary data. Also, the data of cumulative number classified by bid price versus production cost are data of multiplying the cumulative number for every bid price in the primary data by the production unit price of the number of lots which corresponds to the cumulative number for every bid price shown as the estimate bid result of each trader in the primary data.

Thereafter, a table of cumulative number versus sales profit and loss is calculated provisionally for the tertiary data. The table of cumulative number versus sales profit and loss is obtained by finding the difference of the data of cumulative number classified by bid price versus sales in the secondary data and the data of cumulative number classified by bid price versus production cost in the secondary data between the corresponding cells.

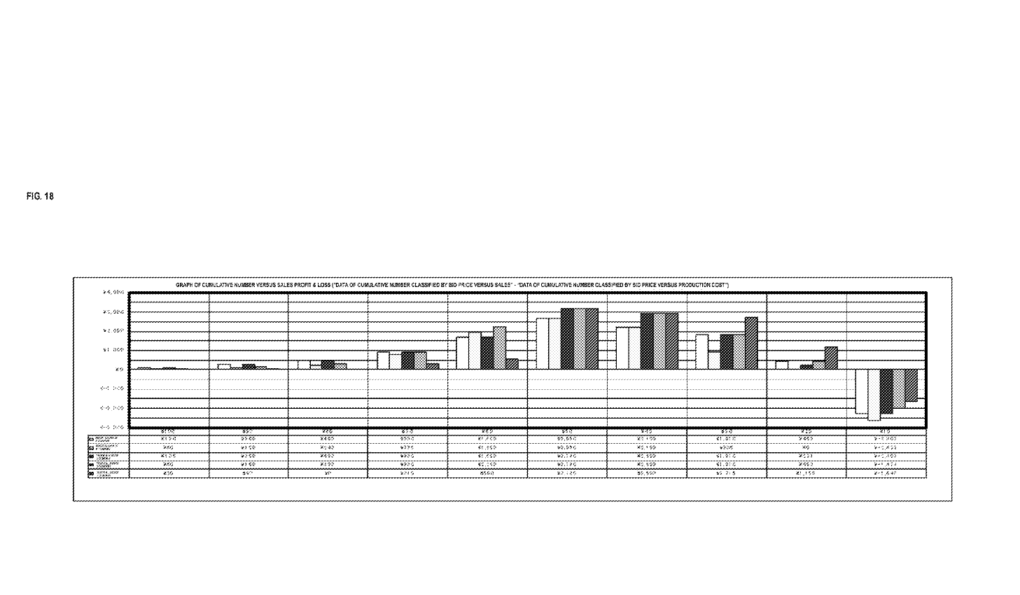

FIG. 18 is a graph of cumulative number versus sales profit and loss in which the table of cumulative number versus sales profit and loss calculated provisionally as the tertiary data is graphed.

According to the case shown in the table 1 and FIG. 18, it is comprehended that the profit amount becomes the maximum of 3180 Yen supposing that the price is 50 Yen and the commodity manufacturer is C company, D company or E company.

As described above, it is possible, based on the table of cumulative number versus sales profit and loss which is the tertiary data or the graph of cumulative number versus sales profit and loss, to determine the profit amount easily even in a case of a combination of various prices, buyer's preferences and traders. Further, it is possible to judge that the profit amount will become the largest by setting which price range and which trader of the idea realization and it becomes possible to execute the selection of the price and the idea realization of the trader easily.

It should be noted here that a process of subtracting the data of cumulative number classified by bid price versus production cost from the data of cumulative number classified by bid price versus sales for every bid price is performed and the bid price in which the value thereof becomes the maximum and the production trader are extracted. However, the determination method is not limited by the simple subtraction and it is allowed to determine which price range and which trader of the idea realization would be appropriate by executing calculation in consideration of various requirements such as the cost, the currency exchange and the like other than the above.

In addition, it may also be allowed that the idea does not relate to commodities or productions but relates to services.

It has been explained up to now on the basis of ┌quantity┘ of the commodity, but it is also allowed to make the ┌idea embodiment quantity┘ responding to the content or the like of the idea such as the service period, the mass of the commodity and the like to be the basis appropriately.

For the ID information, it is allowed to employ not only the information relating to the user or the like dealt with in the present exemplified embodiment but also the information for specifying the user or the like until an arbitrary degree responding to necessity or the like by utilizing an electronic authentication institution or the like.

With respect to the commodity production, a large number of traders could have relations for every region thereof. More specifically, it is allowed to employ a configuration wherein a singular or a plurality of ┌persons who want to receive business for commodification with respect to original idea of commodity┘ associate the estimate amount of money of production unit price for every production-possible number of lots with respect to the ┌portion different in the production region┘, the data of cumulative number classified by bid price versus region classified by production cost is conformed to and subtraction-processed for every region, and the bid price and the cumulative number by which the profit becomes the maximum value are extracted.

A case only for existing commodities and buyers is also allowed. In other words, in case of an existing commodity in which the production cost is already comprehended with respect to the commodity of the exhibitor, it is allowed to extract the bid price and the cumulative number in which the profit becomes the maximum value by processing comparison and subtraction of the existent production cost with respect to the data of cumulative number classified by bid price versus sales which are obtained depending on a fact that the commodity purchase applicant executed bidding.

A case in which commodification is accomplished according to a request from the purchase side auction is also allowed. By making a function in which a purchase applicant executes free request with respect to a commodity plan of an exhibitor to be used practically with respect to the auction site manager, it is possible for a production trader to estimate the commodity according to the request of the purchase applicant and to judge whether or not the release is possible.

With respect to the commodity plan of the exhibitor, it is allowed not only for a person who purchases or purchases of stock only by necessary amount without monopoly but also for a person who has an idea of obtaining returns in the future by executing investment on the idea matter or on the idea holder or an investor, or for a person who tries to obtain profits as his own idea (right) by buying out the idea (right) itself or a subsidizer of the matter to participate in the auction, and the exhibitor may calculate fair investment worth or buyout price by making the ┌data of cumulative number classified by bid price versus sales┘ or the ┌data of cumulative number classified by bid price versus production cost┘ to be a judgment material.

The series of processes mentioned above can be performed by hardware and also can be performed by software. In case of performing the series of processes by software, programs constituting the software thereof are installed in a general-purpose computer or the like.

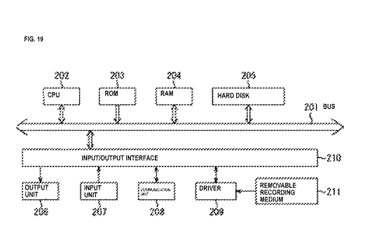

FIG. 19 shows a configuration example of a computer installed with the program which executes the series of processes mentioned above.

The program can be recorded beforehand in a hard disk 205 or a ROM 203 as a recording medium installed in the computer.

Alternatively, it is possible for the program to be stored (recorded) temporarily or permanently in a removable recording medium 211 such as a flexible disk, a CD-ROM (Compact Disc Read Only Memory), a MO (Magneto Optical) disk, a DVD (Digital Versatile Disc), a magnetic disk, a semiconductor memory and the like. It is possible to offer such a removable recording medium 211 as so-called package software.

It should be noted with respect to the program that it is also possible, other than installing it in a computer from the removable recording medium 211 such as mentioned above, to transfer it from a download site to the computer wirelessly through an artificial satellite for digital satellite broadcast or to transfer it to the computer by cable through a network such as LAN (Local Area Network) and internet wherein in the computer, the program transferred in that manner is received by a communication unit 208 and is installed in the built-in hard disk 205.

The computer is installed with a CPU (Central Processing Unit) 202. The CPU 202 is connected with an input/output interface 210 through a bus 201 and when an instruction is inputted by a user according to an operation or the like of an input unit 207 constituted by a keyboard, a mouse, a microphone and the like, the CPU 202 executes the program stored in the ROM (Read Only Memory) 203 in accordance therewith through the input/output interface 210. Alternatively and in addition, CPU 202 loads a program stored in the hard disk 205, a program installed in the hard disk 205 by being transferred from the satellite or the network and being received by the communication unit 208 or a program installed in the hard disk 205 by being read out from the removable recording medium 211 mounted on a driver 209 in a RAM (Random Access Memory) 204 and executes it. Thereby, the CPU 202 performs the process according to the flowchart mentioned above or the process executed by the configuration of the block diagram mentioned above. Then, the CPU 202, when necessary, outputs the process result thereof from an output unit 206 constituted by a display apparatus such as an LCD (Liquid Crystal Display) or the like, a speaker and the like or transmits the process result thereof from the communication unit 208 and further, records the process result thereof in the hard disk 205 or the like, for example, through the input/output interface 210.

Here, it is not always necessary, for the processing steps of writing programs for making the computer to execute various kinds of processes, to be processed in time-series manner along the order described in the flowchart and it should be noted that a process executed parallelly or individually (for example, parallel process or process by object) is also included. It is also possible to make a choice of the steps or omit them when it is necessary.

In addition, the program may be a program processed by a computer and also may be a program processed dispersively by a plurality of computers. Further, the program may be a program which is transferred to a computer faraway to be executed therein.

The system means an object in which a plurality of apparatuses are assembled logically and it is not concerned about whether or not the apparatuses having respective configurations lie within the same housing.

It should be noted that, according to the present exemplified embodiment, it is possible to respond with respect to necessary requests on an occasion of commodification of personal mind-set and sales establishment based on a small-scale production. Also, request & order-reception of business become possible through the present site if the environment of internet utilization is put into place regardless of disadvantage in shortage of financial power and in life region environment or regardless of a disadvantageous situation of mental-physical handicap and the like. Also, it is possible to find out a commodity suited for own request and to accomplish the development thereof. Also, a risk in which a commodity attracting no buyers is released so as to carry an inventory becomes little. Also, it becomes easy to investigate actual costs and selling prices of extensive, various or miscellaneous and visible or invisible commodities and services. Also, the discovery of improvement needs of the existing products becomes easy. Further, the discovery of latent demand buried in the market or ability of latent supply becomes possible.

As mentioned above, it has been explained with respect to the present invention with reference to specific exemplified embodiments. However, it is obvious that those skilled in the art can accomplish amendment or substitution of the aforesaid exemplified embodiments in a scope without departing from the gist of the present invention. More specifically, the present invention has been disclosed in the form of exemplification, so that the described content of the present specification must not be interpreted limitedly. In order to judge the gist of the present invention, the columns of the patent claims described in the beginning must be taken into consideration.

Also, although it is clear that the exemplified embodiments for the explanation of the present invention attain the objects described above, it is definitely possible to understand that those skilled in the art can employ a lot of modifications or other embodiments. It is allowed to employ the elements or the components of the patent claims, the specification, the drawings and each exemplified embodiment for explanation together with other one or combination thereof. The patent claims are intended to include such modifications and other exemplified embodiments within the scope thereof and these are included in the technical thought and the technical scope of the present invention.

### INDUSTRIAL APPLICABILITY

The present invention can be applied also to the use application relating to an information processing apparatus, an information processing method, a recording medium, and a program, and particularly relating, for example, to an auction system.

1. In an auction system in which a first computer and a second computer are connected to an auction unit computer through a communication network, an auction system characterized in that said auction unit computer comprises:
idea information storing means in which idea information is stored;
estimate information storing means in which an embodiment amount of money per embodiment unit quantity which is transmitted from said first computer and responds to idea embodiment quantity is stored by being correlated with said idea information;
auction information storing means in which bid price and bid quantity which are transmitted from said second computer are stored by being correlated with said idea information;
a process of creating data of cumulative total classified by bid price versus sales by processing product calculation of cumulative total for every bid price which is obtained by additively processing bid intention quantity sequentially from high-price bid price to low-price bid price and the corresponding bid price;
a process of creating data of cumulative total classified by bid price versus embodiment cost by processing product calculation of said cumulative total and an embodiment amount of money per embodiment unit quantity which corresponds to said cumulative total; and
extracting means carrying out a process of extracting bid price which satisfies a predetermined condition by comparing said data of cumulative total classified by bid price versus sales and said data of cumulative total classified by bid price versus embodiment cost.

2. The auction system according to claim 1, characterized in that said auction unit computer is further connected with a third computer through a communication network, and said idea information storing means is stored with idea information transmitted from said third computer.

3. The auction system according to claim 1, characterized in that said auction unit computer further comprises means for transmitting said idea information with respect to said first computer or said second computer.

4. The auction system according to claim 1, characterized in that said auction unit computer is further connected with a fourth computer through a communication network, and said auction unit computer further comprises means for receiving payment information corresponding to bidding from said fourth computer.

5. An information processing apparatus characterized by comprising:
idea information storing means in which idea information is stored;
estimate information storing means in which an embodiment amount of money per embodiment unit quantity responding to idea embodiment quantity is stored by being correlated with said idea information;
auction information storing means in which bid price and bid quantity are stored by being correlated with said idea information;
a process of creating data of cumulative total classified by bid price versus sales by processing product calculation of cumulative total for every bid price which is obtained by additively processing bid intention quantity sequentially from high-price bid price to low-price bid price and the corresponding bid price;
a process of creating data of cumulative total classified by bid price versus embodiment cost by processing product calculation of said cumulative total and an embodiment amount of money per embodiment unit quantity which corresponds to said cumulative total; and
extracting means for carrying out a process of extracting bid price which satisfies a predetermined condition by comparing said data of cumulative total classified by bid price versus sales and said data of cumulative total classified by bid price versus embodiment cost.

6. The information processing apparatus according to claim 5, characterized in that said estimate information storing means is stored with an embodiment amount of money per embodiment unit quantity responding to idea embodiment quantity together with ID information of an embodiment person by being correlated with said idea information, and said extracting means further extracts ID information of an embodiment person, which satisfies a predetermined condition.

7. An information processing method characterized by comprising:
an idea information storing step in which idea information is stored;
an estimate information storing step in which an embodiment amount of money per embodiment unit quantity responding to idea embodiment quantity is stored by being correlated with said idea information;
an auction information storing step in which bid price and bid quantity are stored by being correlated with said idea information;
a process of creating data of cumulative total classified by bid price versus sales by processing product calculation of cumulative total for every bid price which is obtained by additively processing bid intention quantity sequentially from high-price bid price to low-price bid price and the corresponding bid price;
a process of creating data of cumulative total classified by bid price versus embodiment cost by processing product calculation of said cumulative total and an embodiment amount of money per embodiment unit quantity which corresponds to said cumulative total; and
an extracting step carrying out a process of extracting bid price which satisfies a predetermined condition by comparing said data of cumulative total classified by bid price versus sales and said data of cumulative total classified by bid price versus embodiment cost.

8. In a program for an information process of an information processing apparatus, a recording medium recorded with a program readable by a computer, characterized by comprising:
an idea information storing step in which idea information is stored;
an estimate information storing step in which an embodiment amount of money per embodiment unit quantity responding to idea embodiment quantity is stored by being correlated with said idea information;
an auction information storing step in which bid price and bid quantity are stored by being correlated with said idea information;
a process of creating data of cumulative total classified by bid price versus sales by processing product calculation of cumulative total for every bid price which is obtained by additively processing bid intention quantity sequentially from high-price bid price to low-price bid price and the corresponding bid price;
a process of creating data of cumulative total classified by bid price versus embodiment cost by processing product calculation of said cumulative total and an embodiment amount of money per embodiment unit quantity which corresponds to said cumulative total; and
an extracting step carrying out a process of extracting bid price which satisfies a predetermined condition by comparing said data of cumulative total classified by bid price versus sales and said data of cumulative total classified by bid price versus embodiment cost.

9. In a program making a computer which controls an information processing apparatus to perform an information process, a program characterized by comprising:
an idea information storing step in which idea information is stored;
an estimate information storing step in which an embodiment amount of money per embodiment unit quantity responding to idea embodiment quantity is stored by being correlated with said idea information;
an auction information storing step in which bid price and bid quantity are stored by being correlated with said idea information;
a process of creating data of cumulative total classified by bid price versus sales by processing product calculation of cumulative total for every bid price which is obtained by additively processing bid intention quantity sequentially from high-price bid price to low-price bid price and the corresponding bid price;
a process of creating data of cumulative total classified by bid price versus embodiment cost by processing product calculation of said cumulative total and an embodiment amount of money per embodiment unit quantity which corresponds to said cumulative total; and
an extracting step carrying out a process of extracting bid price which satisfies a predetermined condition by comparing said data of cumulative total classified by bid price versus sales and said data of cumulative total classified by bid price versus embodiment cost.
